(19) United States
(12) Patent Application Publication
(10) Pub. No.: US 2026/0339945 A1
(43) Pub. Date: Oct. 29, 2026

(54) SyncSense: Structuring Analytical Conversations for Sensemaking and Communication

(71) Applicant: Salesforce, Inc., San Francisco, CA (US)

(72) Inventors: Qi Kun GU, Seattle, WA (US); Srishti PALANI, Palo Alto, CA (US); Vidya Raghavan SETLUR, Portola Valley, CA (US)

(21) Appl. No.: 19/643,644

(22) Filed: Apr. 9, 2026

Related U.S. Application Data
(63) Continuation-in-part of application No. 19/019,351, filed on Jan. 13, 2025.
(60) Provisional application No. 63/710,479, filed on Oct. 22, 2024.
(60) Provisional application No. 63/787,658, filed on Apr. 11, 2025.

(51) Int. Cl. G06F 16/2453; G06F 16/242; G06F 16/28; G06F 40/35

(52) U.S. Cl. CPC G06F 16/24539; G06F 16/243; G06F 16/285; G06F 40/35

(57) ABSTRACT

A computer system receives conversation data representing an analytical conversation between a user and a conversational interface. The computer system constructs, from the conversation data, a structured representation of the analytical conversation in accordance with a framework for analytical conversation components, the structured representation comprising a plurality of analytical conversation components including conversation turns, conversation threads, speech acts, analysis artifacts, and data insights. The computer system stores data identifying a user query and a corresponding response of the conversational interface, a categorization of a respective user query according to an analysis-specific speech act taxonomy, a structured output generated in the analytical conversation and separate from natural language text, and an observation about data referenced in the analytical conversation. The computer system establishes associations among the analytical conversation components and stores the structured representation as a machine-readable representation for subsequent retrieval, summarization, navigation, or reuse.

### RELATED APPLICATIONS

This application is a continuation-in-part application of U.S. patent application Ser. No. 19/019,351, filed Jan. 13, 2025, which claims priority to U.S. Provisional Patent Application No. 63/710,479, filed Oct. 22, 2024, each of which is incorporated by reference herein in its entirety.

This application also claims priority to U.S. Provisional Patent Application No. 63/787,658, filed Apr. 11, 2026, which is incorporated by reference herein in its entirety.

### TECHNICAL FIELD

The disclosed embodiments relate generally to data analysis and more specifically to systems, methods, and user interfaces for structuring analytical conversations for effective insight extraction and generating audience-specific summaries.

### BACKGROUND

Data-related tasks often involve analysis, collaboration, and sharing among different users. Chat-based interfaces are increasingly used for data exploration and analysis. However, these interfaces often lack features to synthesize critical insights during data exploration, hindering the ability to extract and share key findings efficiently.

### SUMMARY

Data-related tasks can span from problem definition to data collection, analysis, communication, and decision-making. Data-related tasks often involve collaboration and information-sharing among different users.

With the development of artificial intelligence (AI) models such as large language models (LLMs), AI chat assistants (e.g., chatbots) are becoming increasingly prevalent. AI chat assistants are computer programs designed to simulate human-like conversations, often using natural language processing (NLP) and machine learning (ML) techniques. AI chat assistants can be applied to facilitate user exploration of, interactions with, and analyses of data. For example, after uploading their data, a user can converse with an AI chat assistant to clean, shape, and transform the data. In some instances, the AI chat assistant can also build visualizations and answer data-driven questions. The benefits of applying AI chat assistants to data-related tasks include (i) lowering barriers to conducting data analysis (ii) making data-related accessible to people with little or no coding experience, (iii) saving time by allowing users to start more quickly by expressing broad, high-level intents, which can then be refined through ongoing conversation with the AI assistant; and (iv) enabling users to externalize their intentions and assumptions and preserving the provenance of their analytical steps, which are often hidden or lost in tools like computational notebooks.

Despite the benefits of AI chatbots, current chat-based interfaces tend to lack essential features of data analysis tools to support sharing. At the present, analyses are often shared as a static history of the entire conversation, which can be long, repetitive, and unstructured, with no concise summary of the key analytical insights to share with an intended audience. Critically, these shared artifacts do not support the varied information-seeking and sense-making needs of consumers of these analyses. Consequently, important insights may be obscured, and the process of sharing analysis results becomes time-consuming and inefficient. Current AI conversational platforms also perform poorly when it comes to extracting key information or tailoring summaries for different audiences such as technical experts or business decision-makers. For example, different groups of users may desire different levels of detail from the data analysis. Some users may want to continue, repurpose, or reuse the analysis, which require certain technical details, while other users may want to quickly make decisions and identify key takeaways based on the analyses. To support these different needs, different components of the conversation need to be emphasized. In other words, there is a need to summarize the analytical conversation—including the visualizations, text, and code—at different levels of detail and abstraction. Current conversational AI platforms fall short in terms of extracting and sharing insightful results across diverse audiences and formats.

Accordingly, there is a need for tools that support sharing of analytical conversations in a structured manner. There is also a need for tools that facilitate the generation of audience-specific summaries of analytical conversations at varying levels of detail.

Some embodiments of the present disclosure address the limitations of current AI conversational platforms, by implementing a system—also referred to herein as SyncSense—for structuring analytical conversations, such as those generated in LLM-based data analysis workflows, so users can more easily revisit, understand, and communicate those analyses. The present disclosure introduces a framework for analytical conversation components, which organizes an analytical conversation into several component types: turns, threads, speech acts, analysis artifacts, and data insights. Turns are prompt-response pairs. Threads are coherent analytical sub-conversations, including nested sub-threads. Speech acts categorize the user's analytical intent, such as fact finding, deep insights, specific visualization, data transformations, refinement, recommendation, domain knowledge, and debugging. Artifacts include outputs such as visualizations, data tables, and code. Insights are meaningful observations about the data and are classified using an insight taxonomy including value, proportion, difference, distribution, trend, rank, aggregation, association, extreme, categorization, and outlier. Applying this framework, SyncSense automatically extracts those components from an analytical conversation and displays them across multiple synchronized interface panels. In some embodiments, the interface panels include an Outline panel that provides a high-level overview of conversation structure; a Detail Explorer panel that presents an intermediate view with expandable threads and nested content; an Annotated Conversation panel that shows the underlying raw conversation annotated with component labels; and an Authoring Panel that allows a user to drag and drop selected components into a structured editing environment to create summaries. For instance, users can select threads, turns, insights, or artifacts; rearrange and nest them; serialize them into markdown; and then use AI-assisted controls to refine the resulting communication based on parameters such as length, technical detail, and formality. SyncSense is designed to preserve transparency and user control by showing source content and enabling direct human editing rather than fully automating the communication task.

As disclosed, the multiple synchronized interface panels enable synchronization across different views of the conversation, at multiple levels of abstraction, and support users in managing complex conversations that may involve many turns, nested topics, and/or different artifacts. For example, users can navigate a high-level timeline that shows the sequence of conversation turns, or they can dive deeper into a more detailed view that focuses on insights and associated artifacts. SyncSense enables filtering by speech act (e.g., data comparison, fact-finding) or artifact type (e.g., code, visualizations), making it easy to locate specific parts of the conversation. This flexibility ensures that different audiences, ranging from technical experts to business decision-makers, can interact with the conversation at the level of detail that suits their needs. SyncSense also preserves provenance, meaning that all summary components retain a link back to their original context within the conversation. This is particularly important for verifying insights or tracing how conclusions were reached during an analysis. The provenance feature is integrated into the system's navigation, so users can click on a summary element and be taken directly to the corresponding section of the original conversation. SyncSense is also configured to present data insights to a wide range of audiences (e.g., technical and non-technical) while customizing the content to specific user needs.

In some embodiments, SyncSense leverages large language models (LLMs) by identifying components within an analytical conversation that can be summarized and shared efficiently. SyncSense is configured to structure conversations into components such as conversation turns, insights, and artifacts. These components are dynamically extracted from the conversation, allowing users to interact with and explore the content in a structured way. For instance, a conversation turn might represent a user's query and the AI's response, which can include artifacts like visualizations, code, data tables, or insights (critical data points derived during the analysis), are also extracted and categorized for easy access and navigation.

As disclosed, the technical advantages of SyncSense over current AI chat platforms and content summarization tools include (1) enhanced ability for a user to efficiently navigate, explore, and share conversational insights; (2) time savings in terms of time spent on manually crafting summaries and reviewing lengthy conversation logs, more efficient workflows for different target audiences; (3) reduced cognitive load on users; (4) simplifying the process of continuing, reusing, or repurposing ongoing analyses; (5) enabling users to make faster and more informed decisions, by quickly identifying the most important insights from a conversation, improving data-driven decision-making processes. This streamlined workflow helps team members contribute more effectively without needing to sift through irrelevant or repetitive information.

The systems, methods, and user interfaces of this disclosure each have several innovative aspects, no single one of which is solely responsible for the desirable attributes disclosed herein.

In accordance with some embodiments, a method for generating machine-readable representations of analytical conversations is performed at a computer system that includes one or more processors and memory. The method includes receiving conversation data representing an analytical conversation between a user and a conversational interface. The method includes constructing, from the conversation data, a structured representation of the analytical conversation in accordance with a framework for analytical conversation components, wherein the structured representation comprises a plurality of analytical conversation components, including at least two of: one or more conversation turns, one or more conversation threads, one or more speech acts, one or more analysis artifacts, and one or more data insights. The method includes storing, for each respective conversation turn of the one or more conversation turns, data identifying a user query and a corresponding response of the conversational interface. The method includes storing, for each respective conversation thread of the one or more conversation threads, data identifying a coherent sequence of related conversation turns centered around an analytical topic or goal. The method includes storing, for each respective speech act of the one or more speech acts, a categorization of a respective user query according to an analysis-specific speech act taxonomy. The method includes storing, for each respective analysis artifact of the one or more analysis artifacts, data identifying a structured output generated in the analytical conversation and separate from natural language text. The method includes storing, for each respective data insight of the one or more data insights, data identifying an observation about data referenced in the analytical conversation. The method includes establishing associations among the analytical conversation components, including associating respective speech acts with respective conversation turns, associating respective analysis artifacts with respective conversation turns, associating respective data insights with one or more respective conversation turns, and associating respective conversation turns with respective conversation threads. The method includes storing the structured representation as a machine-readable representation of the analytical conversation for subsequent retrieval, summarization, navigation, or reuse.

In accordance with some embodiments, a computer system includes one or more processors and memory coupled to the one or more processors. The memory stores one or more programs configured for execution by the one or more processors. The one or more programs include instructions for performing any of the methods disclosed herein.

In accordance with some implementation, a non-transitory computer readable storage medium stores one or more programs configured for execution by a computer system having one or more processors, and memory. The one or more programs include instructions for performing any of the methods disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIG. 1 illustrates a workflow for generating adaptable summaries from an analytical conversation via SyncSense, in accordance with some embodiments.

FIG. 2 provides a block diagram of a computing device, in accordance with some embodiments.

FIG. 3 provides a block diagram of a server system, in accordance with some embodiments.

FIG. 4 provides speech act types, definitions, and examples, in accordance with some embodiments.

FIG. 5 provides insight types, their definitions, and examples, in accordance with some embodiments.

FIGS. 6A to 6G illustrate various views of the SyncSense user interface, in accordance with some embodiments.

FIGS. 7A to 7AG are screenshots illustrating user interactions with SyncSense, in accordance with some embodiments.

FIGS. 8A and 8B provide a flowchart of an example process for generating machine-readable representations of analytical conversations, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

In many data-analysis workflows, a user interacts with a conversational interface over a series of turns to explore data, generate visualizations, inspect tables, revise prompts, and refine analytical reasoning. As these analytical conversations grow, the resulting conversation history can become long, linear, and difficult to navigate, particularly when explanations, code, visualizations, tables, and intermediate observations are interwoven across multiple topics. Important insights may as a result be difficult to re-find, verify, or communicate, and a static conversation log may provide little assistance in identifying what portions of the analysis are to be surfaced for a particular purpose or audience. These limitations can increase the effort required to revisit prior work, trace how a conclusion was reached, and prepare a communication that is appropriately tailored in technical depth, emphasis, and format.

To address these issues, some embodiments provide a computer-implemented framework that structures an analytical conversation into multiple analytical conversation components, such as conversation turns, conversation threads, speech acts, analysis artifacts, and data insights, and stores associations among those components in a machine-readable representation. In some embodiments, the structured representation is used to drive multiple synchronized interface views at different levels of abstraction, thereby enabling a user to navigate among high-level conversation structure, intermediate grouped content, and underlying source conversation content while preserving provenance between summarized content and original context. In some embodiments, the computer system further enables selective extraction and arrangement of the structured components to generate audience-specific communications, including summaries at different levels of detail, while permitting direct user editing and optional AI-assisted refinement so that the resulting output can be adapted without requiring the user to reconstruct the analysis from an unstructured conversation history.

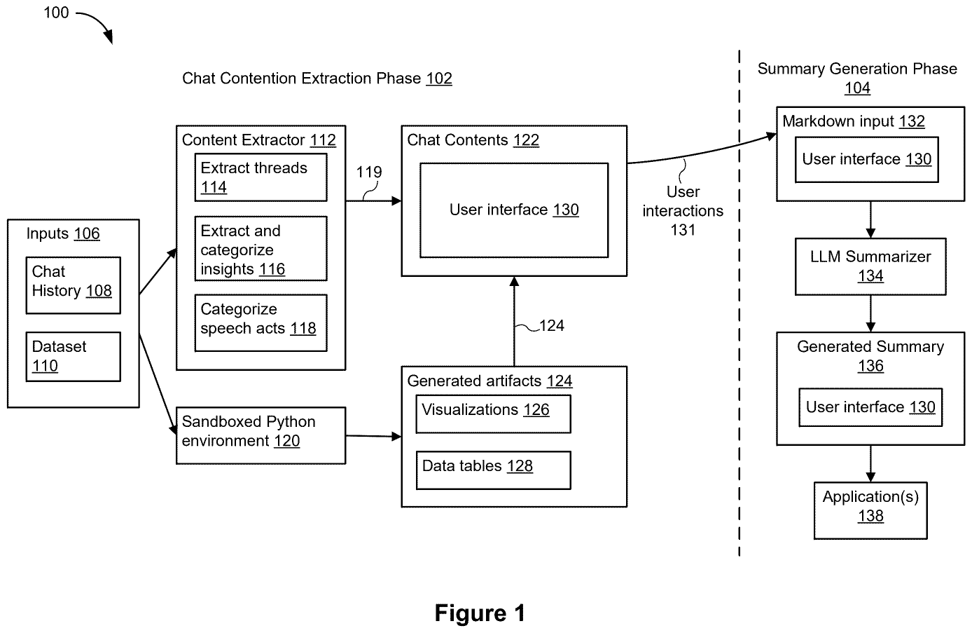

FIG. 1 illustrates a workflow 100 for generating adaptable summaries from an analytical conversation via SyncSense, in accordance with some embodiments. The workflow 100 includes a chat content extraction phase 102 and a summary generation phase 104.

In the content extraction phase 102, SyncSense receives inputs 106, including chat history 108 (e.g., via a URL) of an analytical conversation and a dataset 110. SyncSense executes the code from the chat history 108 and uses data from the dataset 110 to generate artifacts (e.g., generated artifacts 124 or structured output). In some embodiments, SyncSense uses a sandboxed Python environment 120 with the exact libraries used in OpenAI's code execution environment to execute the code, thus ensuring consistent artifacts are produced. SyncSense applies content extractor 112 to extract, from the chat history, other conversational components 119 such as conversation threads, insights, and speech acts. In some embodiments, content extractor 112 is an AI model (e.g., data processing models 258). In some embodiments, content extractor 112 is a large language model (LLM) (e.g., LLM(s) 260). In some embodiments, content extractor 112 uses three LLM modules (three separate LLM API calls) to extract threads 114, extract and categorize insights 116, and categorize speech acts 118, as illustrated in FIG. 1. In some embodiments, SyncSense uses OpenAI's GPT-4o for LLM-based functionalities. In some embodiments, to extract threads for analysis, SyncSense prompts the content extractor 112 (e.g., LLM) to summarize each turn-pair in the conversation. It then iteratively merges sub-threads based on their similarity, as determined by the content extractor 112. Preliminary experiments by the inventors indicated that this iterative merging approach is more stable compared to using a single prompt. In some embodiments, the generated artifacts 124 and the other conversational components 119 are displayed as chat contents 122 on user interface 130, via one or more panels.

A user can interact (e.g., via user interactions 131) with chat contents 122 that are displayed in the user interface. For example, the user can drag content (e.g., text, images, or artifacts that the user would like included in the summary from one or more panels of the user interface to an authoring panel of the user interface to generate markdown input 132, which is displayed in the user interface 130. In the summary generation phase 104, an LLM summarizer 134 takes the markdown input 132 and user configurations in the post-drop editor as input to adapt and generate (via an API call) a summary (e.g., generated summary 136). In some embodiments, SyncSense uses OpenAI's GPT-4o for summary generation. In some embodiments, SyncSense displays the generated summary 136 in the user interface 130. In some embodiments, SyncSense enables the generated summary 136 to be exported to external application(s) such as a messaging application, an email application, email, a data presentation/communication application, or a reporting software application.

In some embodiments, SyncSense is implemented in the React framework based on Typescript using the Ant Design library for UI components. It uses React Drag and Drop (DnD) for the drop container and MDX Editor for the markdown editor. The backend is implemented in Python using FastAPI, which is designed to extract the chat contents from ChatGPT's conversation JSON object, execute the code within the chat, and generate summaries. A sandboxed Python environment with the exact libraries obtained through prompting ChatGPT Data Analyst used in OpenAI's code execution environment is used to execute the code, ensuring consistent artifacts are produced. For all LLM-based functionalities, OpenAI's GPT-4o is used. Specifically, these tasks include (1) extracting threads from the conversation, (2) extracting the speech act from each user query, (3) extracting and categorizing insights from the conversation, and (4) generating the updated summary given the markdown input.

### Block Diagrams

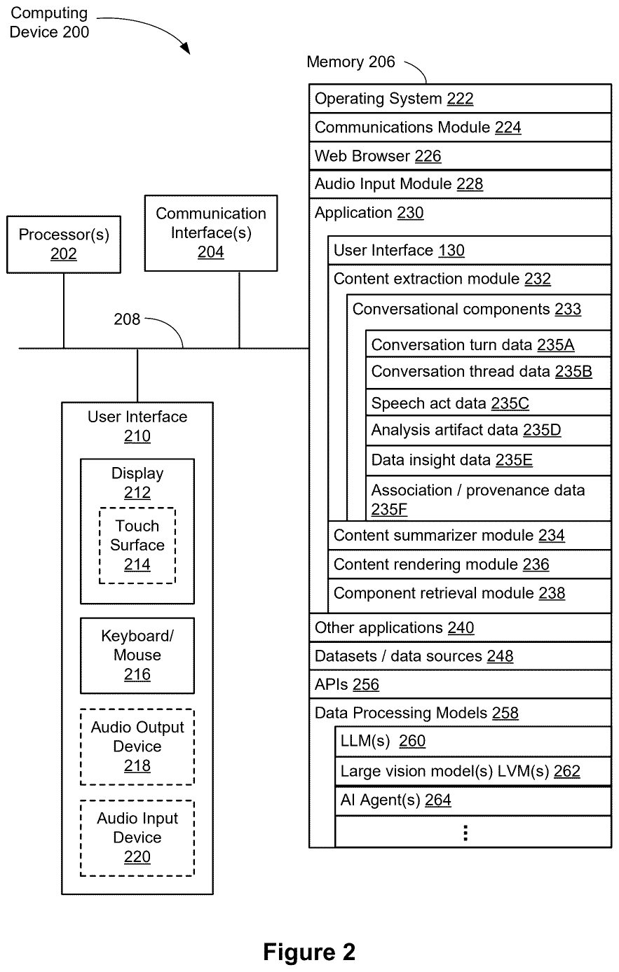

FIG. 2 is a block diagram of a computing device 200, in accordance with some embodiments. Various examples of the computing device 200 include a desktop computer, a laptop computer, a tablet computer, and other computing devices that have a display and a processor capable of running an application 230 (e.g., SyncSense). In some embodiments, the computing device 200 is a virtual reality (VR) device, an augmented reality (AR) device, or a spatial computing device that blends digital content with the physical world. The computing device 200 typically includes one or more processing units (processors or cores) 202, one or more network or other communication interfaces 204, memory 206, and one or more communication buses 208 for interconnecting these components. In some embodiments, the communication buses 208 include circuitry (sometimes called a chipset) that interconnects and controls communications between system components.

The computing device 200 includes a user interface 210. The user interface 210 typically includes a display device 212. In some embodiments, the computing device 200 includes input devices such as a keyboard, mouse, and/or other input buttons 216. Alternatively or in addition, in some embodiments, the display device 212 includes a touch-sensitive surface 214, in which case the display device 212 is a touch-sensitive display. In some embodiments, the touch-sensitive surface 214 is configured to detect various swipe gestures (e.g., continuous gestures in vertical and/or horizontal directions) and/or other gestures (e.g., single/double tap). In computing devices that have a touch-sensitive display 214, a physical keyboard is optional (e.g., a soft keyboard may be displayed when keyboard entry is needed). The user interface 210 also includes an audio output device 218, such as speakers or an audio output connection connected to speakers, earphones, or headphones. Furthermore, some computing devices 200 use a microphone and voice recognition (e.g., audio input device 220) to supplement or replace the keyboard. In some embodiments, the computing device 200 includes an audio input device 220 (e.g., a microphone) to capture audio (e.g., speech from a user).

In some embodiments, the memory 206 includes high-speed random-access memory, such as DRAM, SRAM, DDR RAM, or other random-access solid-state memory devices. In some embodiments, the memory 206 includes non-volatile memory, such as one or more magnetic disk storage devices, optical disk storage devices, flash memory devices, or other non-volatile solid-state storage devices. In some embodiments, the memory 206 includes one or more storage devices remotely located from the processors 202. The memory 206, or alternatively the non-volatile memory devices within the memory 206, includes a non-transitory computer-readable storage medium. In some embodiments, the memory 206, or the computer-readable storage medium of the memory 206, stores the following programs, modules, and data structures, or a subset or superset thereof:
an operating system 222, which includes procedures for handling various basic system services and for performing hardware dependent tasks;
a communications module 224, which is used for connecting the computing device to other computers (e.g., server 300) and devices via the one or more communication interfaces 204 (wired or wireless), such as the Internet, other wide area networks, local area networks, metropolitan area networks, and so on;
a web browser 226 (or other application capable of displaying web pages), which enables a user to communicate over a network with remote computers or devices;
an audio input module 228 (e.g., a microphone module), which processes audio captured by the audio input device 220. The captured audio may be sent to a remote server (e.g., a server system 300) and/or processed by an application executing on the computing device 200;
an application 230 (e.g., SyncSense). In some embodiments, the application 230 includes:
   a user interface 130 (e.g., also known as a graphical user interface, or GUI, as illustrated in FIGS. 1, 6A to 6G, and 7A to 7AG);
   a content extraction module 232 (e.g., content extractor 112). In some embodiments, content extraction module 232 is configured to extract conversational components 233 from chat histories of analytical conversations with datasets and datasets. In some embodiments, the conversational components 233 include conversation turns (e.g., turn pairs), speech acts; analysis artifacts (e.g., ode, visualizations, table, or execution output), data insights (e.g., numerical or statistical results derived from data in the dataset and/or chat history), and conversation threads and/or sub-threads. In some embodiments, content extraction module 232 is configured to construct, from a chat history of an analytical conversation, a structured representation in accordance with a framework for analytical conversation components;
   conversational components 233 storing the structured representation as a machine-readable representation of the analytical conversation.
   In some embodiments, the conversational components 233 include conversation turn data 235A identifying, for each respective conversation turn, a user query and a corresponding response of a conversational interface. In some embodiments, the conversational components 233 include conversation thread data 235B identifying, for each respective conversation thread, a coherent sequence of related conversation turns centered around an analytical topic or goal. In some embodiments, the conversational components 233 include speech act data 235C identifying, for each respective speech act, a categorization of a respective user query according to an analysis-specific speech act taxonomy. In some embodiments, the conversational components 233 include analysis artifact data 235D identifying, for each respective analysis artifact, a structured output generated in the analytical conversation and separate from natural language text. In some embodiments, the conversational components 233 include data insight data 235E identifying, for each respective data insight, an observation about data referenced in the analytical conversation. In some embodiments, the conversational components 233 include association/provenance data 235F associating respective speech acts with respective conversation turns, associating respective analysis artifacts with respective conversation turns, associating respective data insights with one or more respective conversation turns, and associating respective conversation turns with respective conversation threads.
   a content summarizer module 234;
   a content rendering module 236 for generating and displaying user interface 130. In some embodiments, the content rendering module 236 renders the plurality of conversational components as interactive affordances on the user interface; and
   component retrieval module 238 configured to receive a user interaction identifying a selected analytical conversation component of the machine-readable representation and, in response, retrieve one or more additional analytical conversation components associated with the selected analytical conversation component based on the association data for subsequent retrieval, summarization, navigation, or reuse.
   one or more other applications 240. For example, in some embodiments, the one or more other applications 240 can include a messaging application such as Slack®, an email application, a data presentation/communication application such as Microsoft PowerPoint®, Tableau Software ®, Microsoft PowerBI®, or a reporting software application;
   zero or more datasets or data sources 248 (e.g., dataset 110), which are used by the application 230, the one or more other applications, and/or data processing models 258;
   APIs 256 for receiving API calls from one or more applications (e.g., a web browser 226, an application 230, other applications 240) and/or data processing models 258, translating the API calls into appropriate actions, and performing one or more actions; and
   data processing models 258. In some embodiments, the data processing models 258 are applied to process datasets 248. In some embodiments, the data processing models 258 include one or more large language models (LLMs) 260, one or more large vision models (LVMs) 262, and one or more AI agents 264. In some embodiments, the data processing models 258 include rule-based systems or statistical models.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 206 stores a subset of the modules and data structures identified above. Furthermore, the memory 206 may store additional modules or data structures not described above. In some embodiments, a subset of the programs, modules, and/or data stored in the memory 206 is stored on and/or executed by a server system 300.

Although FIG. 2 shows a computing device 200, FIG. 2 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 200 may be stored or executed on a server system 300.

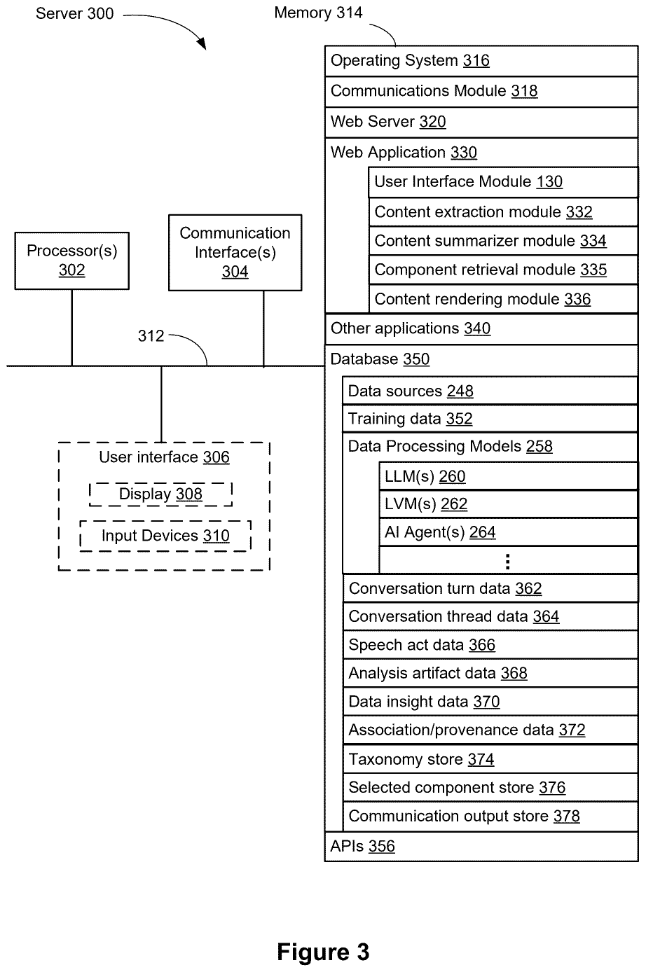

FIG. 3 is a block diagram of a server system 300 (e.g., a computer system), in accordance with some embodiments. The server system 300 typically includes one or more processing units/cores (CPUs) 302, one or more network interfaces 304, memory 314, and one or more communication buses 312 for interconnecting these components. In some embodiments, the server system 300 includes a user interface 306, which includes a display 308 and one or more input devices 310, such as a keyboard and a mouse. In some embodiments, the communication buses 312 include circuitry (sometimes called a chipset) that interconnects and controls communications between system components.

In some embodiments, the memory 314 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. In some embodiments, the memory 314 includes one or more storage devices remotely located from the CPUs 302. The memory 314, or alternatively the non-volatile memory devices within the memory 314, comprises a non-transitory computer readable storage medium.

In some embodiments, the memory 314 or the computer readable storage medium of the memory 314 stores the following programs, modules, and data structures, or a subset thereof:
an operating system 316, which includes procedures for handling various basic system services and for performing hardware dependent tasks;
a network communications module 318, which is used for connecting the server 300 to other computers via the one or more communication network interfaces 304 (wired or wireless) and one or more communication networks, such as the Internet, other wide area networks, local area networks, metropolitan area networks, and so on;
a web server 320 (such as an HTTP server), which receives web requests from users and responds by providing responsive web pages or other resources;
a web application 330 (e.g., SyncSense web application), which may be downloaded and executed by a web browser 226 on a user's computing device 200. In general, a web application 330 has the same functionality as application 230, but provides the flexibility of access from any device at any location with network connectivity, and does not require installation and maintenance. In some embodiments, the web application 330 includes various software modules to perform certain tasks, such as:
   a user interface module 130, which provides the user interface for all aspects of the web application 330;
   a content extraction module 332. In some embodiments, content extraction module 332 has the same functionalities as content extraction module 232. In some embodiments, the content extraction module 332 is configured to construct, from conversation data representing an analytical conversation, a structured representation in accordance with a framework for analytical conversation components and to store the structured representation in database 350 as a machine-readable representation of the analytical conversation;
   a content summarizer module 334, which has the same functionalities as content summarizer module 234;
   a component retrieval module 335 configured to receive a user interaction identifying a selected analytical conversation component of the machine-readable representation and, in response, retrieve from database 350 one or more additional analytical conversation components associated with the selected analytical conversation component based on the association data, wherein the retrieved analytical conversation components are provided to the content summarizer module 334 and/or the content rendering module 336 for subsequent retrieval, summarization, navigation, or reuse; and
   a content rendering module 336, which has the same functionalities as content rendering module 236;
one or more other applications 340. For example, in some embodiments, the one or more other applications 340 can include a chart application, an email application, or a data processing application In some embodiments, the other applications 340 can include a messaging application such as Slack®, a data presentation/communication application such as Microsoft PowerPoint®, Tableau Software®, Microsoft PowerBI®, or a reporting software application;
database 350. In some embodiments, the database 350 includes:
   zero or more datasets or data sources 248, which are used by web application 330, other applications 340, and/or data processing models 258;
   training data 352 for training the data processing models 258; and
   one or more data processing models 258. In some embodiments, the data processing models 258 include one or more large language models (LLMs) 260, one or more large vision models (LVMs) 262, and one or more AI agents 264; and
APIs 356 for receiving API calls from one or more applications (e.g., a web server 320, a web application 330, and other applications 340) and the one or more data processing models 258, translating the API calls into appropriate actions, and performing one or more actions.

In some embodiments, the database 350 stores conversation turn data 362 identifying, for each respective conversation turn, a user query and a corresponding response of a conversational interface. In some embodiments, the database 350 stores conversation thread data 364 identifying, for each respective conversation thread, a coherent sequence of related conversation turns centered around an analytical topic or goal. In some embodiments, the database 350 stores speech act data 366 identifying, for each respective speech act, a categorization of a respective user query according to an analysis-specific speech act taxonomy. In some embodiments, the database 350 stores analysis artifact data 368 identifying, for each respective analysis artifact, a structured output generated in the analytical conversation and separate from natural language text. In some embodiments, the database 350 stores data insight data 370 identifying, for each respective data insight, an observation about data referenced in the analytical conversation. In some embodiments, the database 350 stores association/provenance data 372 associating respective speech acts with respective conversation turns, associating respective analysis artifacts with respective conversation turns, associating respective data insights with one or more respective conversation turns, and associating respective conversation turns with respective conversation threads.

In some embodiments, the database 350 includes a taxonomy store 374. In some embodiments, the taxonomy store 374 stores taxonomy data used in connection with the framework for analytical conversation components. The taxonomy data may include speech act taxonomy data defining a set of speech act categories for classifying user queries in an analytical conversation and insight taxonomy data defining a set of data insight categories for classifying observations about data referenced in the analytical conversation. In some embodiments, the taxonomy store 374 further stores labels, definitions, mapping rules, version data, and other metadata associated with the speech act taxonomy data and the insight taxonomy data. The content extraction module 332, the content summarizer module 334, and the content rendering module 336 may access the taxonomy store 374 to classify analytical conversation components, to interpret previously classified analytical conversation components, and to generate outputs based on taxonomy-specific classifications

In some embodiments, the database 350 includes a selected component store 376. In some embodiments, the selected component store 376 stores data identifying one or more analytical conversation components selected for subsequent processing. The selected analytical conversation components may include one or more conversation turns, one or more conversation threads, one or more speech acts, one or more analysis artifacts, and one or more data insights. In some embodiments, the selected component store 376 further stores ordering data, hierarchical relationship data, association data, session data, user-specific selection data, and other metadata for the selected analytical conversation components. In some embodiments, the selected component store 376 is updated in response to a user interaction identifying a selected analytical conversation component of the machine-readable representation, and stores the selected analytical conversation component together with one or more additional analytical conversation components retrieved based on association data stored in the database 350.

In some embodiments, the database 350 includes a communication output store 378. In some embodiments, the communication output store 378 stores one or more communication outputs generated from analytical conversation components. A communication output may include, for example, a summary, a report, a presentation outline, a message, or another generated communication based on a selected subset of the analytical conversation components. In some embodiments, the communication output store 378 further stores intermediate representations, prompt data, generation parameter data, revision data, version data, and linkage data associating respective portions of a communication output with corresponding analytical conversation components from which the respective portions were generated. The content summarizer module 334 may write generated communication outputs to the communication output store 378, and the content rendering module 336 may access the communication output store 378 to provide the generated communication outputs for retrieval, editing, navigation, reuse, or further summarization.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 314 stores a subset of the modules and data structures identified above. Furthermore, the memory 314 may store additional modules or data structures not described above.

Although FIG. 3 shows a server system 300, FIG. 3 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 300 may be stored or executed on a computing device 200. In some embodiments, the functionality and/or data may be allocated between a computing device 200 and one or more servers 300. Furthermore, one of skill in the art recognizes that FIG. 3 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

### Framework for Analytical Conversation Components

Existing conversational interface tools often lack explicit representations of the underlying elements that comprise an analytical exchange. To address this gap, some embodiments introduce a structured framework that captures components of an analytical conversation by annotating raw dialogue with its constituent parts. This structured representation and its components are grounded in prior work on chatbot and dialogue systems, particularly those focused on data analysis, and form the premise of the design and implementation of the SyncSense tool. In some embodiments, the framework for analytical conversation components is applied to derive elements such as threads, speech acts, artifacts, and insights.

In some embodiments, the components of an analytical conversation include turns, also referred to as conversation turns or analysis turns. Analysis turns are user query (e.g., prompt) and conversational interface response pairs. In some embodiments, an analysis turn consists of a user query (e.g., prompt) and a response from a Chatbot. An analytical conversation is a sequence of turn taking between the user and the conversational interface. Conversation turns can help data workers quickly identify their analytical intents in a conversation.

In some embodiments, the components of an analytical conversation include threads, also referred to as conversation threads or analysis threads. An analysis thread is a coherent sequence of related conversation turns centered around a specific analytical topic or goal. Data analysis is an iterative and exploratory process, often involving deep dives into or revisiting a previously explored analysis thread. Although current commercial conversational interface systems are primarily single-threaded conversations, they still naturally contain threads useful for navigation and organization of analysis contents. In addition, nested threads (where a thread can be nested within a larger thread) naturally serve as different abstraction levels to the contents of a conversation and provide necessary structure as the analyses grow in length and complexity. A thread can contain sub-threads and/or turns. A leaf thread includes two or more (potentially non-consecutive) turns.

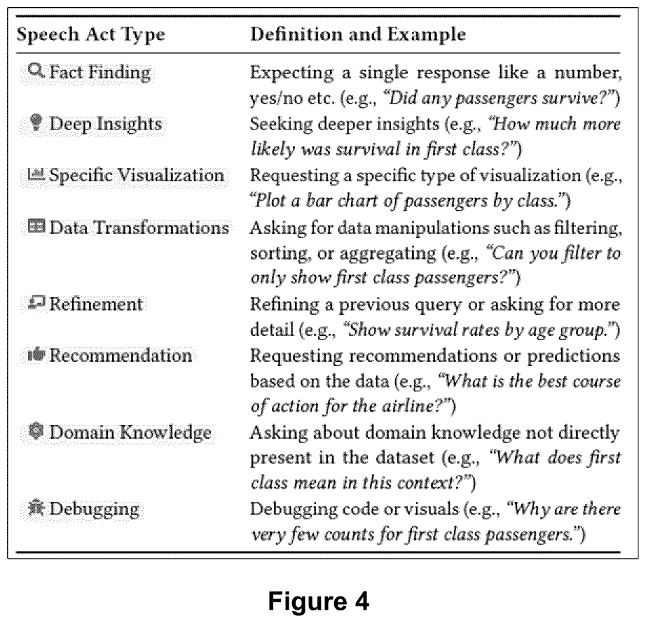

In some embodiments, the components of an analytical conversation include speech acts. A speech act is an utterance that performs an action by the user. In analytical conversations, user prompts can be categorized into analysis-specific speech acts. FIG. 4 provides speech act types, definitions, and examples, in accordance with some embodiments. Prior work on summarizing group conversations highlights the importance of speech acts in providing structure and context to discussions. Various embodiments of the present disclosure focus on speech acts specific to analytical conversations, expanding on the categorization of analytical intents proposed by Setlur et al. in “Inferencing Underspecified Natural Language Utterances in Visual Analysis,” Proceedings of the 24th International Conference on Intelligent User Interfaces (Marina del Ray, California) (IUI '19), Association for Computing Machinery, New York, NY, USA, 40-51, which is incorporated by reference herein in its entirety. The present disclosure adapts and extends their framework to incorporate additional categories relevant to modern LLM-based analysis tools, which increasingly act as general assistants beyond the direct execution of low-level data analysis tasks. These additional categories include Recommendation, Refinement, Domain Knowledge, and Debugging.

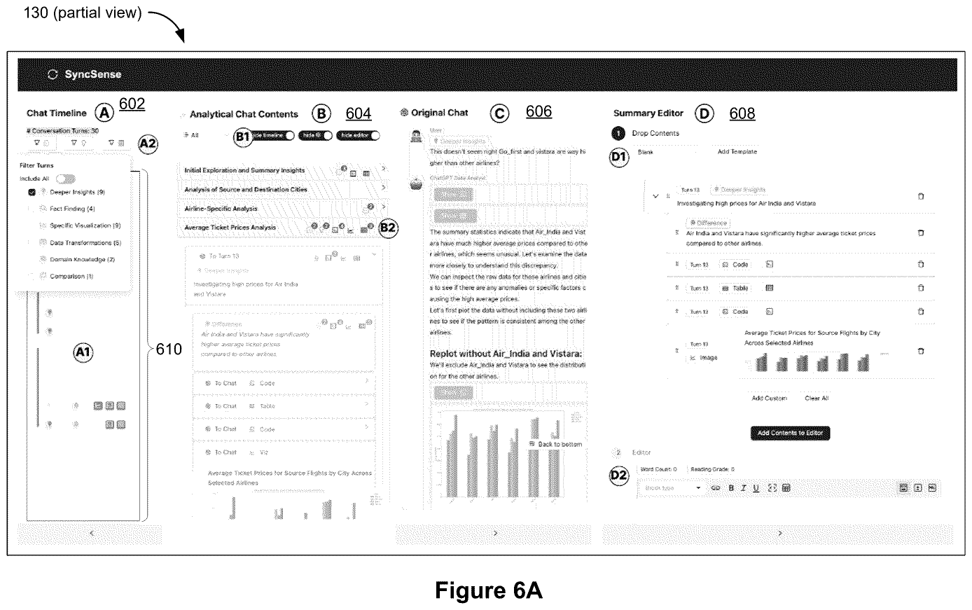

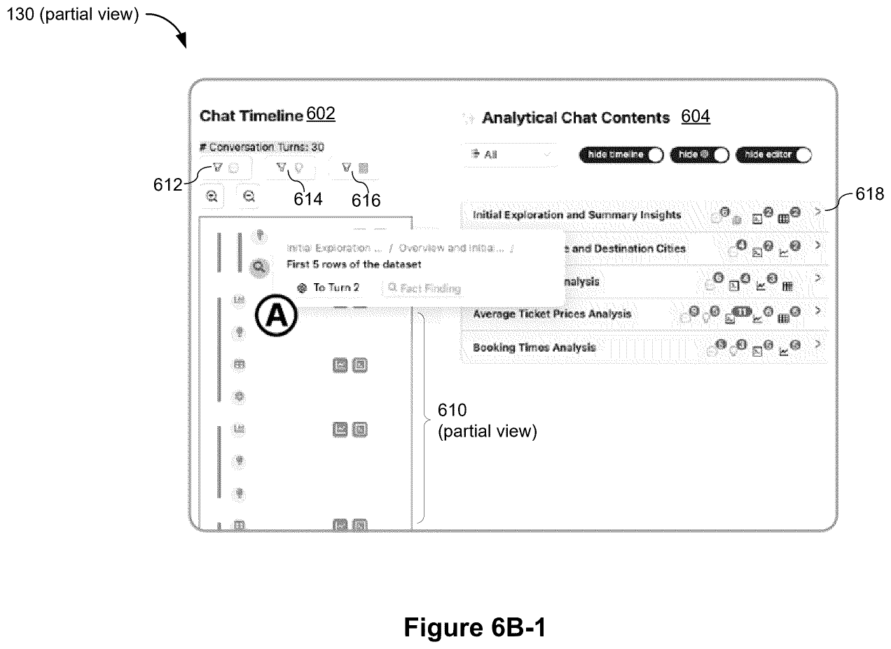

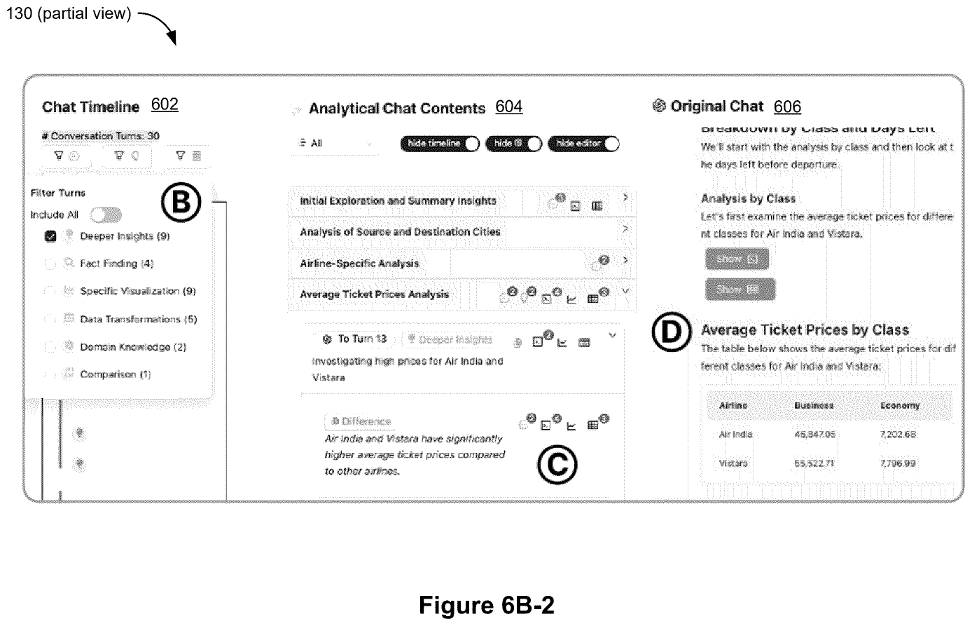

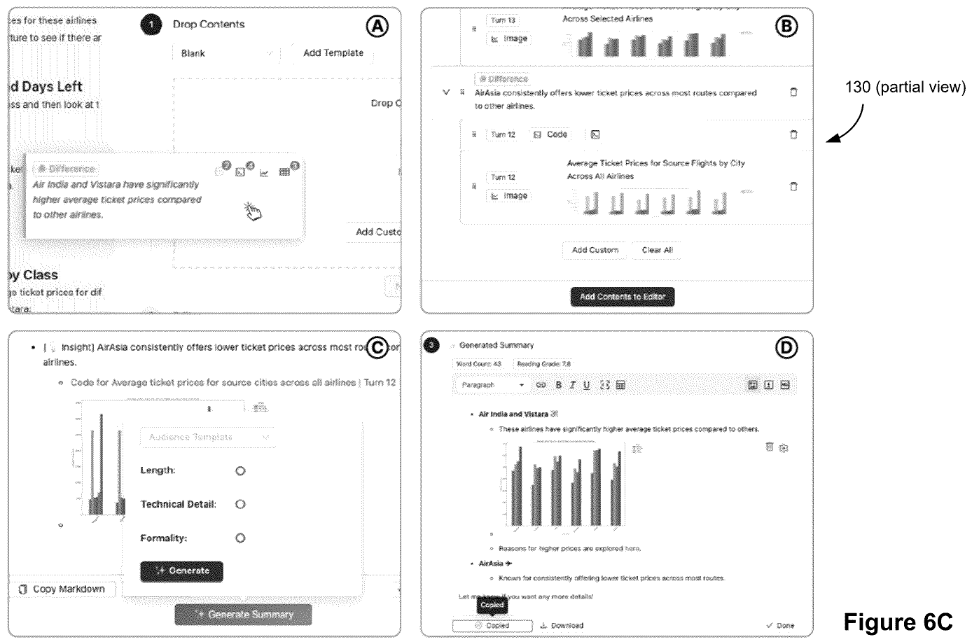

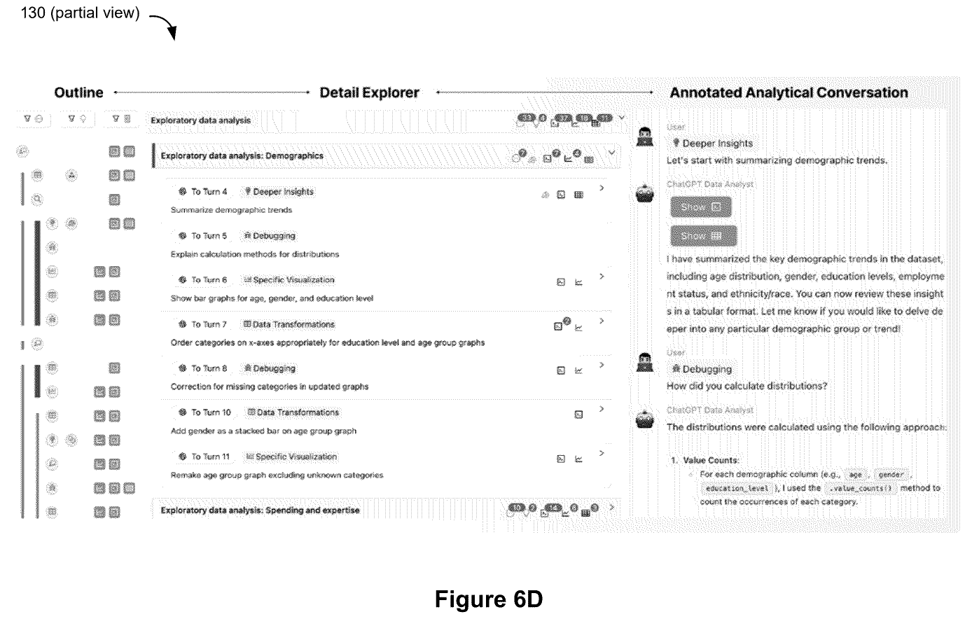

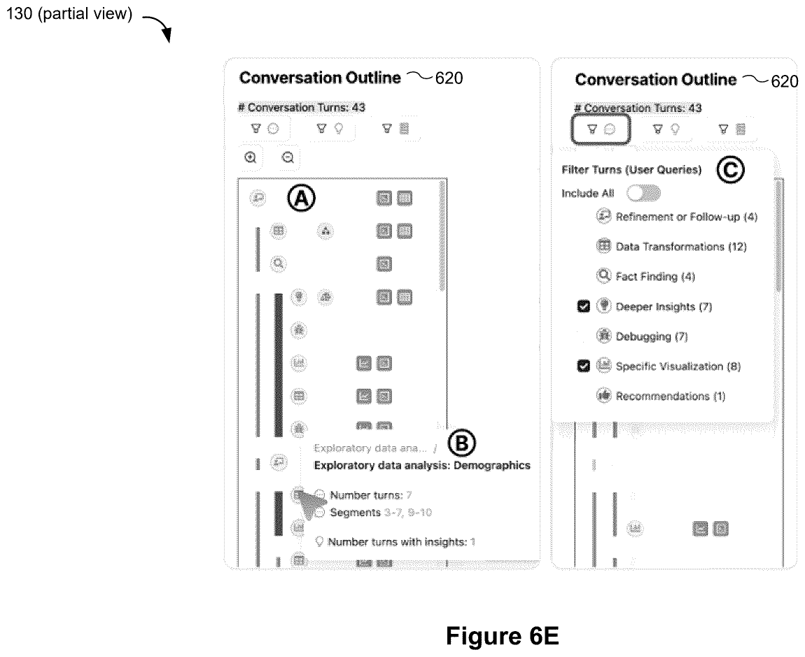

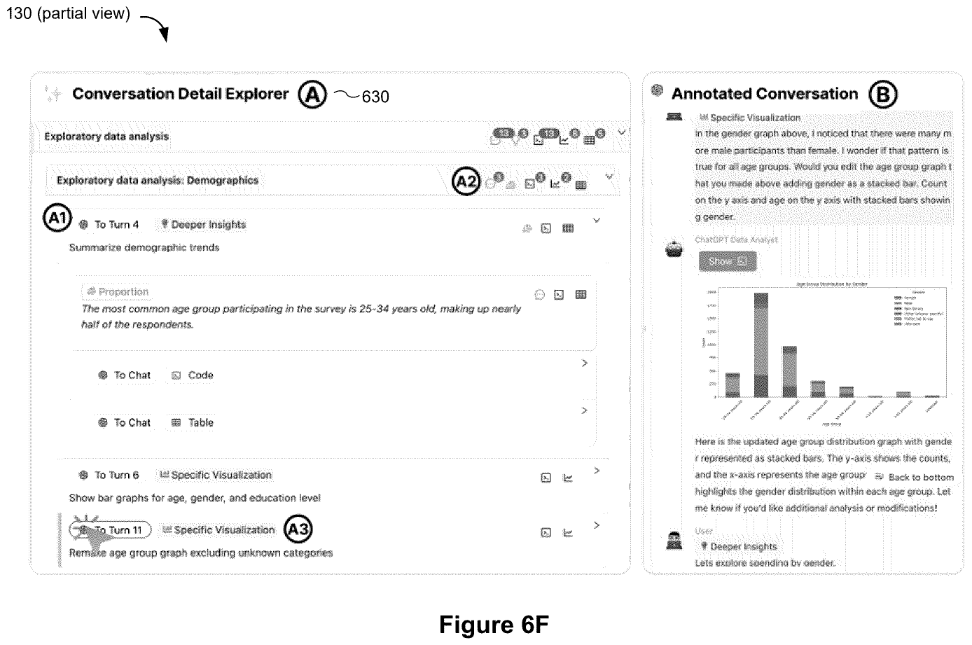

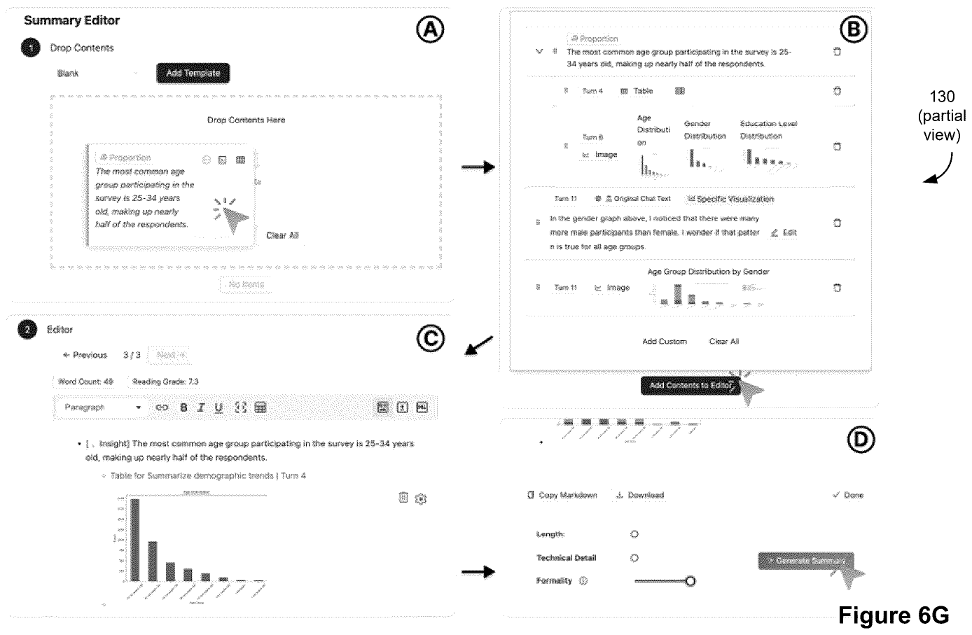

In some embodiments, the components of an analytical conversation include analysis artifacts. Artifacts are structured outputs separate from natural language text that the analytical conversational interface generates. They include visualizations, data tables, and code. In each conversational response, there can be zero or more artifacts associated with the analysis that are relevant to the analytical conversation (see, e.g., panel A in FIG. 6E, where each icon represents a respective component of an analytical conversation). Visualizations and data tables serve as essential components in the presentation of data analyses while code and execution outputs can help with the provenance and verification of how visualizations and tables were generated.

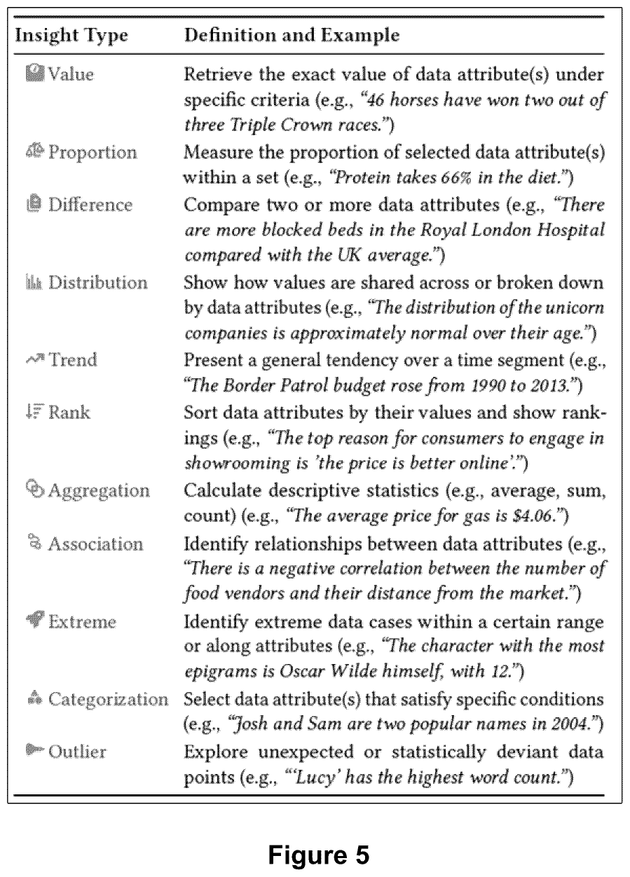

In some embodiments, the components of an analytical conversation include analysis insights. Data insights are meaningful observations about the data and represent critical outcomes of any analysis (see panel A in FIG. 6E). In analytical conversations, however, prior work has highlighted the challenge of uncovering insights, as they are often buried within back-and-forth exchanges, lengthy text, and embedded artifacts. Additionally, organizing these insights can be difficult due to the volume and complexity of information. To support better structure and retrieval, some embodiments treat insights as key components of the conversation and associate them with one or more turns. FIG. 5 provides insight types, their definitions, and examples, in accordance with some embodiments. In some embodiments, insights are classified using a taxonomy as illustrated in FIG. 5. The taxonomy is adapted from Wang et al. in “DataShot: Automatic Generation of Fact Sheets from Tabular Data,” IEEE Transactions on Visualization and Computer Graphics 26 (2020), 895-905, which is incorporated by reference herein in its entirety.

### Syncsense Tool

SyncSense extracts and presents chat contents as structured components across different levels of abstraction. It offers a drag-and-drop interface for composing summaries, along with an editor for making refinements. To support these features, SyncSense uses a multi-panel layout. In some embodiments, arranged from highest-level overview to most detailed view, the panels are: the Conversation Outline (or Outline), the Conversation Detail Explorer (or Detail Explorer), and the Annotated Conversation. The Authoring panel supports the creation and editing of conversation summaries using the extracted components.

SyncSense is implemented in the React framework based on Typescript using the Ant Design library for UI components. React DnD is used for the drop container and MDX Editor is used for the markdown editor. The backend is implemented in Python using FastAPI, which is designed to extract the chat contents from ChatGPT's conversation JSON object, execute the code within the chat, and generate summaries. A sandboxed Python environment is used, with the exact libraries obtained through prompting Chat-GPT Data Analyst used in OpenAI's code execution environment to execute the code, ensuring consistent artifacts are produced. For all LLM-based functionalities, OpenAI's GPT-4o is used. Specifically, these tasks include (1) extracting threads from the conversation, (2) extracting the speech act from each user query, (3) extracting and categorizing insights from the conversation, and (4) generating the updated summary given the markdown input. Example prompts are described in U.S. patent application Ser. No. 19/019,351, filed Jan. 13, 2025, which is incorporated by reference herein in its entirety.

To provide structure to an analytical conversation to both better support navigation and provide a common language for constructing a summary from conversation contents, SyncSense breaks the raw conversation down into meaningful components relevant to the navigation needs.

FIGS. 6A, 6B-1, 6B-2, 6C, 6D, and 6E illustrate various views of the SyncSense user interface (e.g., user interface 130), in accordance with some embodiments.

FIG. 6A shows that the user interface 130 includes a chat timeline panel 602 (panel A in FIG. 6A) having a chat timeline 610 for surfacing key components of the conversation (e.g., conversational components 233), thereby offering a quick overview of the entire conversation. In some embodiments, each component type (e.g., conversational components 233) is represented by a respective distinct icon in the timeline, with the icons arranged to follow the natural structure in the conversation as illustrated in FIG. 6A and 6B-1. Therefore, turns appear in the order they occurred in the original discussion, and each row represents each turn. Likewise, the speech act, insights, and artifacts associated with the turn are also present in the row. To ensure a consistent visual language throughout SyncSense's other panels, each component type (e.g., threads, speech acts/turns, insights, and artifacts) is represented in its own color. Because speech acts represent the user query turn in a turn-pair, some embodiments overload the color for turns with that of speech acts. When applicable, additional icons are used to help identify the exact type of the chat component (e.g., the speech act category or the insight type). In addition, nested threads are shown in blue as vertical bars to indicate which turns in the conversation are associated with that thread. The threads are nested vertically (parent threads to the left of child threads) to show the natural abstraction of conversation threads. Advantageously, the multi-level abstraction feature enables users to engage with conversations at varying levels of detail and enables summaries to be customized depending on the audience.

The chat timeline panel 602 can include an iconized timeline (A1) and filtering options (A2). FIG. 6B shows that above the chat timeline 610, filter options (e.g., facets) are included. The filter options include a filter option 612 for filtering speech acts (e.g., filter the turns in the conversation), a filter option 614 for filtering insight types, and a filter option 616 for filtering the artifact types (e. g., the code, data tables, and visualizations). The filter options, when selected, not only update the icons residing in the chat timeline 610 but also those in the analytical chat contents panel 604. In some embodiments as disclosed, SyncSense enables the categorization of user queries based on intent categories (e.g., speech act categories) such as comparison, fact-finding, or recommendations and facilitates the process of quickly filtering and navigating conversations. This speech act categorization is particularly useful for managing complex conversations and stands out against competitor tools that lack this level of intent-based filtering and organization.

To support detail on demand, hovering over threads, speech acts, or insights reveals additional information about the hovered component. Clicking on an icon will display the corresponding component in both the analytical chat contents panel 604 and the original chat panel 606, allowing users to navigate directly to the relevant content for more details and trace back to the original conversation. Similarly, clicking on artifact icons opens a popover showing artifacts of that type for the selected turn. In some embodiments, clicking is used instead of hovering to display the popover, as popovers take up more screen space and could obstruct the interface if shown accidentally. The popover includes buttons for quick navigation to the related content in both the analytical chat contents panel 604 and the original chat panel 606.

FIGS. 6A, 6B-1, and 6B-2 show that the user interface 130 includes an analytical chat contents panel 604 (e.g., panel B in FIG. 6A) that offers multiple view options (B1 in FIG. 6A) and icons indicating nested content for each component (B2 in FIG. 6A), in accordance with some embodiments.

The analytical chat contents panel 604 enables more in-depth exploration of the chat contents compared to the chat timeline 610, while still maintaining an abstracted view compared to the raw conversation. In some embodiments, to accommodate different information-seeking needs, the analytical chat contents panel 604 includes three distinct views, each structured to emphasize the most relevant information for the task. Within these views, related components are nested under parent components that can be revealed by clicking the “>” button 618. In some embodiments, the views include “All View,” “Turn View,” and “Insights View.” “All View” displays threads and turns at the top level, with artifacts and insights nested within them. “Turn View” lists all turns in sequence, along with their associated artifacts and insights. “Insights View” prioritizes insights, nesting the relevant turns and artifacts beneath each one. The different views (e.g., “All View,” “Turn View,” and “Insights View”) enables users to engage with conversations at varying levels of detail, according to specific needs and contexts, and differentiates from other existing solutions that typically provide static, one-size-fits-all summaries.

In some embodiments, for each insight, turn, or thread, relevant tags are displayed with consistent iconography and coloring that matches the chat timeline 610, offering users a quick visual overview. In some embodiments, to assist users in orienting themselves within the conversation, hovering over the contents in the Analytical Chat Contents panel triggers an increase in the size of the corresponding icon in the chat timeline 610. In some embodiments, to help users get a sense of the contents nested within a content block, icons representing the content e.g., turns, artifacts, or insights) with the counts of that content are presented.

In some embodiments, the user interface 130 includes original chat panel 606 (Panel C in FIG. 6A, and FIG. 6B-2). In some embodiments, to help users maintain the provenance of the extracted content relative to the original chat and to provide additional context and verification, SyncSense provides the original raw conversation in the original chat panel 606. Displaying original raw conversation in the original chat panel 606 also helps to differentiate SyncSense's LLM-extracted content and non-LLM generated content. Unlike current ChatGPT shared chats, which do not even include visualization contents in the original chat panel 606 can include all artifacts and can be navigated from the other abstracted panels.

In some embodiments, the user interface 130 includes a summary editor panel 608 (panel D in FIG. 6A), which is an authoring panel for creating custom summaries. Users can drag elements from the analytical chat contents panel 604 or the original chat panel 606 into the summary editor panel 608, and restructure the contents from there.

While the previous panels (e.g., chat timeline panel 602, analytical chat contents panel 604, original chat panel 606) facilitate navigation and information retrieval, the summary editor panel 608 enables users to quickly craft summaries based on conversation components. FIG. 6C illustrates details of the summary editor panel 608, in accordance with some embodiments. The summary editor panel 608 includes the drag-and-drop container, illustrated in panels A and B of FIG. 6C, a post-drop editor, illustrated in panel C of FIG. 6C, and a post-LLM editor, illustrated in panel D of FIG. 6C. Overall, SyncSense aims to provide an intuitive experience for composing summary content through drag-and-drop interactions and LLM-assisted manipulations, while also allowing precise control over the content via markdown edits.

Drag and Drop Container. Prior work on supporting writing with speech has found that breaking down the entire text into semantically meaningful segments and supporting actions on these segments helps authors review and create spoken content more effectively. Some embodiments of the present disclosure we provide a drag-and-drop container that allows users to quickly assemble summary content. Users can drag any chat component (e.g., thread, turn, insight, or artifact) from the Analytical Chat Contents panel into this container. Items dragged will include all nested content, with the hierarchy preserved. Each content item appears as a block, with nested elements indented. In addition, to support copying of text directly from the original conversation, users can also drag any text or artifact in the original chat panel 602. Each block in the container is fully draggable, enabling easy reorganization of order and nesting structure. Once users are satisfied with the arrangement, they can click the “Add Contents to Editor” button. This action serializes the chat contents into markdown, with each item in the container becoming a bullet point in the editor and nested components as indented bullets. For some chat components, additional metadata is added to indicate the type of content (e.g., an insight will be prefixed with “[Insight]”).

Post Drop Editor. Users can edit the plain markdown in the editor, which supports features like code, images, and tables. The post drop editor provides a structured and readable view of the chat contents in markdown format. If users require further assistance in refining their summary, they can click the “Generate Summary” button. This opens sliders that allow users to adjust the content, and an LLM generates a refined summary, which is displayed in a separate post-LLM editor. The content in the markdown editor serves as the input to the LLM, ensuring transparency in how the final summary is produced.

Post-LLM Editor. The post-LLM editor contains the output of the LLM-generated summary. Users can make additional adjustments if necessary. To allow portability to different mediums (e.g., documents and messaging platforms), users can copy or download the markdown contents when they are finished.

FIGS. 6D and 6E illustrate additional views of the user interface 130, in accordance with some embodiments. In the example of FIG. 6D, SyncSense extracts and presents components of an analytical conversation at varying levels of abstraction. SyncSense allows users to interact with the analytical conversations via a high-level Outline (e.g., chat timeline 602), a medium-level Detail Explorer (e.g., analytical chat contents 604), and an in-depth fully Annotated Conversation. The Outline panel provides a high-level overview of the conversation components, the Detail Explorer panel displays additional details about each components, and the Annotated Conversation panel shows the raw conversation annotated with each component. These three synchronized panels are connected visually and interactively through components of the derived framework for analytical conversational components described above. SyncSense also provides the ability to selectively extract these components when crafting summaries.

FIG. 6D shows that the user interface 130 may include an Outline panel in some embodiments. To surface the key components of the conversation and offer an overview of the entire conversation, the Outline panel presents each component as a small icon, and the components are sequentially arranged vertically to follow the flow of the original conversation, as depicted in FIG. 6E. The speech acts, artifacts, and insights associated with each turn are presented horizontally in the row corresponding to that turn. Threads are shown in blue as vertical bars across turns in the conversation they are associated with that thread. Sub-threads are nested to the right of their higher-level thread. To support detail on demand, hovering over the components reveals additional information about them, as illustrated in panel B of FIG. 6E, Clicking on an icon will display the corresponding component in the Detail Explorer panel, allowing users to navigate directly to the relevant content for more details and trace back to the original conversation. Similarly, clicking on artifact icons opens a popover showing artifacts of that type for the selected turn. The popover includes buttons for quick navigation to the related content in both the Detail Explorer and Annotated Conversation panels. To filter to specific components, such as the speech acts, insights, and/or artifacts, a user can use the filters at the top of the panel, as illustrated in panel C of FIG. 6E. This filter not only updates the icons residing in the Outline but also those in the Detail Explorer panel.

FIG. 6D depicts the user interface 130 may include a Detail Explorer panel. The Detail Explorer panel enables a more in-depth exploration of the chat contents compared to the Outline panel while still maintaining an abstracted view compared to the raw conversation that is depicted in panel A of FIG. 6F. Turns and their corresponding components are nested under threads (see, e.g., FIG. 6F, bubble A1), and can be revealed by clicking the dropdown (“>”) button. To help users get a sense of the contents nested within a content block, icons representing the content (i.e., turns, artifacts, or insights) with the counts of that content are presented, as illustrated in bubble A2 of FIG. 6F. To assist users in orienting themselves within the conversation, hovering over the contents in the Detail Explorer panel triggers an increase in the size of the corresponding icon in the Outline. To support detail on demand, users can click the To Turn button, which opens the Annotated Conversation and scrolls to the corresponding turn, as illustrated in bubble A3 of FIG. 6F.

FIG. 6D further depicts the user interface 130 may include an Annotated Conversation panel. To support the provenance of extracted and abstracted components SyncSense presents the original raw analytical conversation in the Annotated Conversation panel. To help browse the conversation, it is annotated with speech act tags and artifact type icons from the Framework for Analytical Conversation Components, as shown in bubble B in FIG. 6F.

FIG. 6E shows that the Outline panel offers a visual overview of the conversation by displaying components (i.e., threads, speech acts, insights, and artifacts) as vertically arranged icons following the dialogue turns (A). Hovering over icons reveals additional details (B). Users can filter by speech acts, insights, and artifacts which update the outline view and the contents in the Detail Explorer (C).

FIG. 6F illustrates the Detail Explorer and Annotated Conversation panels. The Detail Explorer panel presents a structured, mid-level view of the conversation (A). Threads can be expanded to reveal individual turns and components (A1). Icons with content counts summarize nested elements (A2). Clicking the To Turn button navigates to the corresponding turn in the (A3). The displays the full raw conversation, annotated with speech act tags and artifact icons to support provenance and traceability (B).

FIG. 6G are views depicting an Authoring panel of the user interface 130, in accordance with some embodiments. The Authoring panel supports the crafting of summaries using conversation components, including summary composition, authoring, and LLM-based refinement. As disclosed, the Authoring panel combines drag-and-drop interactions with LLM-assisted refinements, while allowing precise control through markdown edits.

SyncSense provides a drag-and-drop container that allows users to quickly assemble summary content. Users can drag any chat component (e.g., thread, turn, insight, or artifact) from the Detail Explorer panel or Annotated Conversation into this container, as illustrated in panel A of FIG. 6G. Items dragged will include all nested content, with the hierarchy preserved. Each content item appears as a block, with nested elements indented. Users can edit the text of the components by clicking on the text of the dropped component, and they can add their own notes by adding a custom block. Users can reorder dropped content by dragging any block. Once users are satisfied with the content, they can click the “Add Contents to Editor” button, as shown in panel B of FIG. 6G. This action serializes the chat contents into markdown, with each item in the container becoming a bullet point in the editor and nested components as indented bullets. For some chat components, additional metadata indicates the type of content (e.g., an insight will be prefixed with “[Insight]”). Users can edit the plain markdown in the editor, as illustrated in panel C of FIG. 6G. Code and data tables are included as links to a raw file, while visualizations are included as inline images. Users can refine their summary by adjusting sliders for length, technical detail, and formality. Length is included as a key output factor for summarization, while technical detail and formality reflect purpose-driven factors (i.e., the context in which the summary is used and the needs of its audience). The content in the markdown editor serves as the input to the LLM, ensuring transparency in how the final summary is produced. When the Generate button is clicked, a refined summary-generated by an LLM based on these settings—is written into the editor. Summary versions are saved as history snapshots, allowing users to browse and revert to previous iterations. Users can copy or download the markdown content when finished.

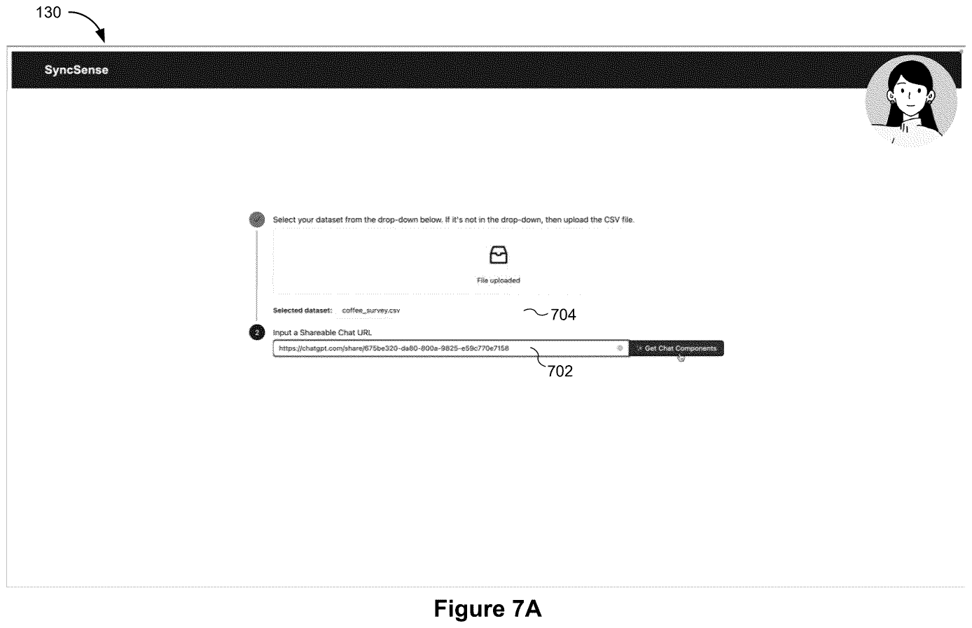

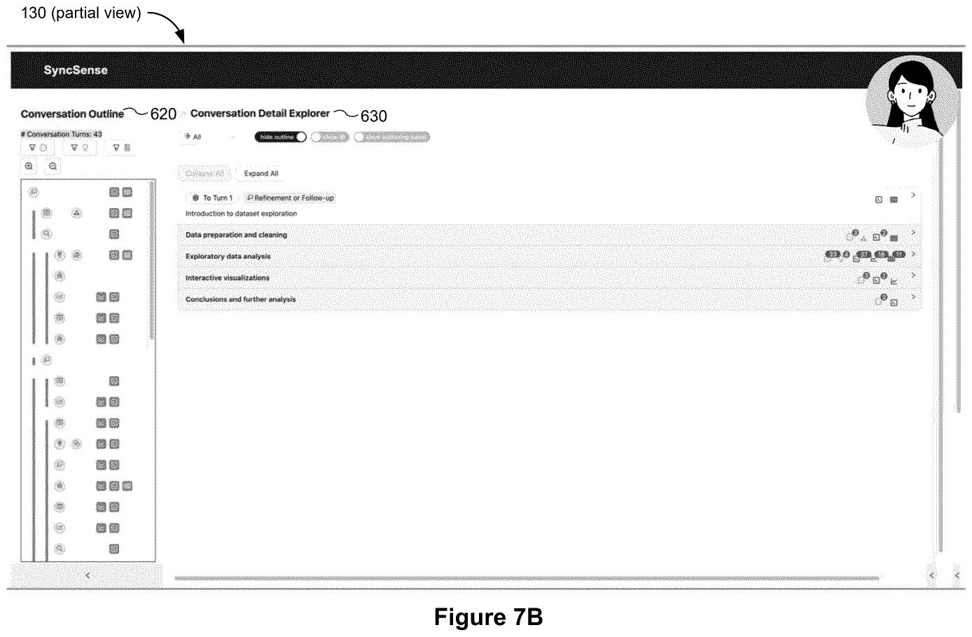

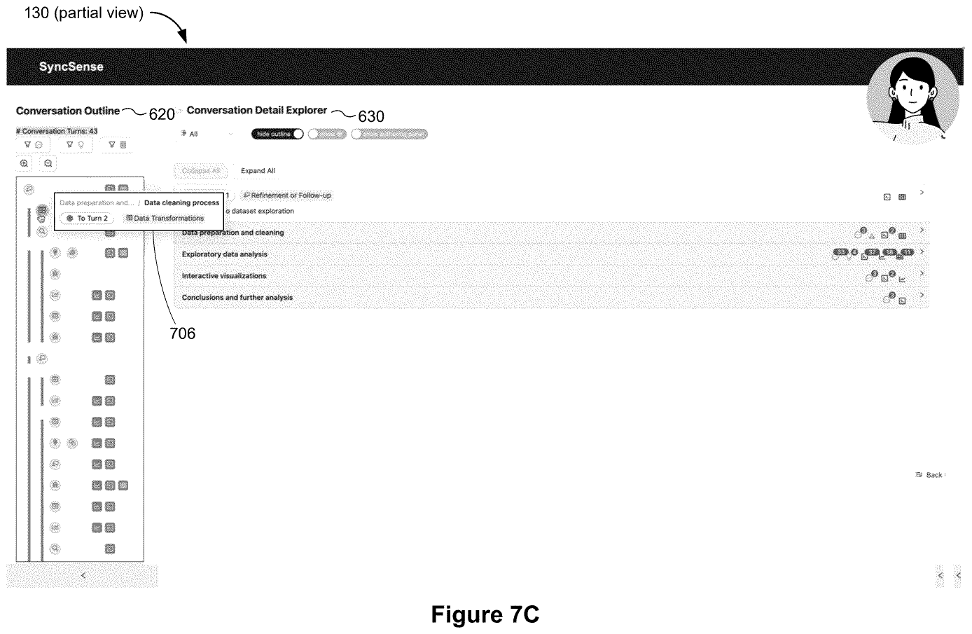

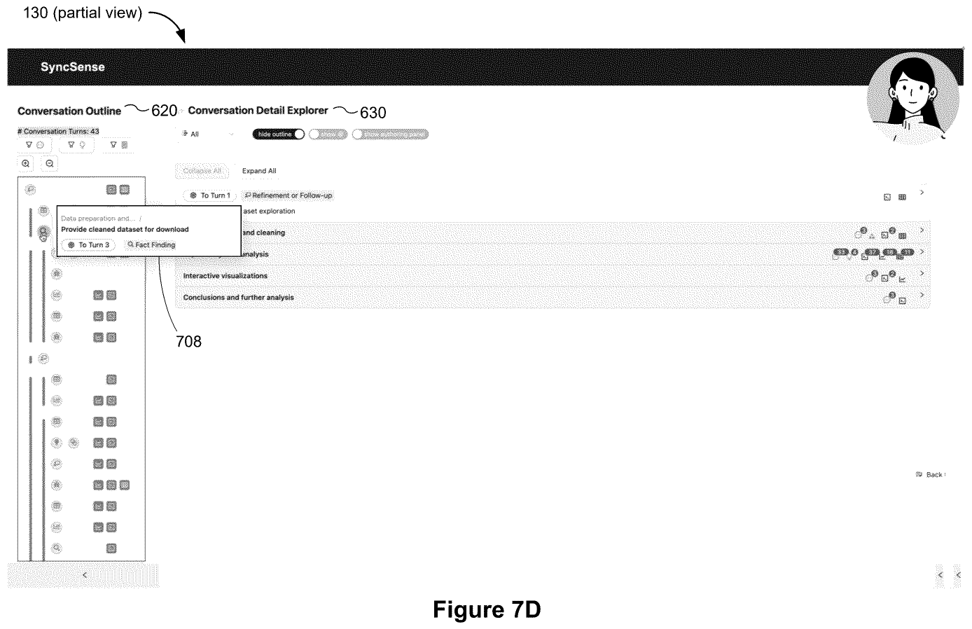

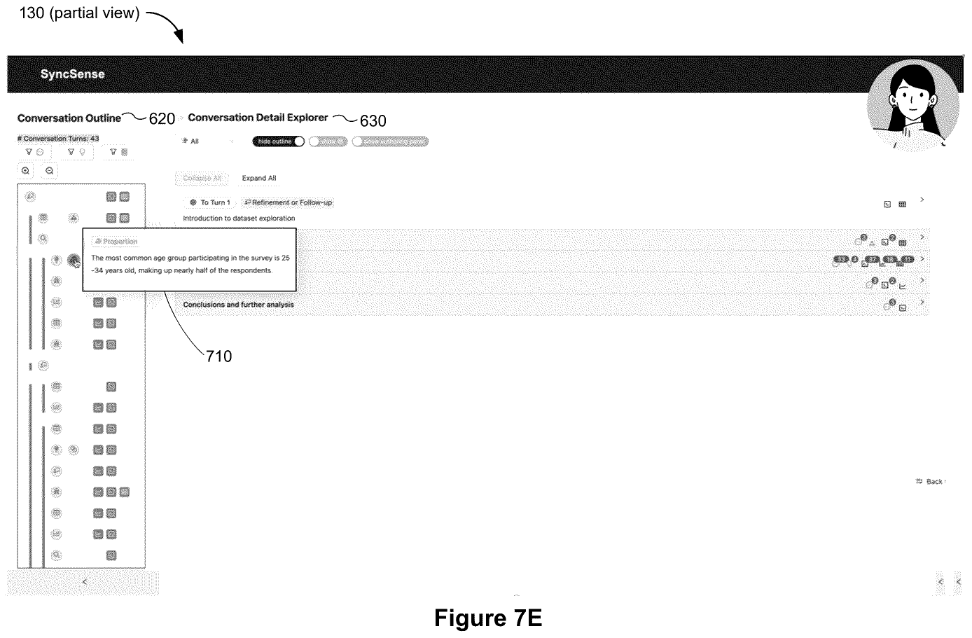

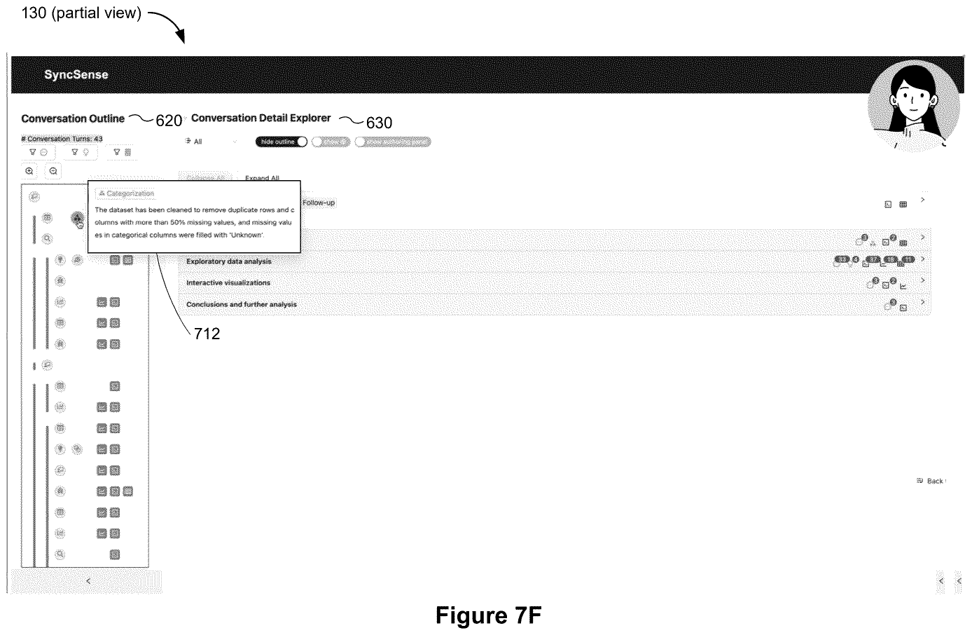

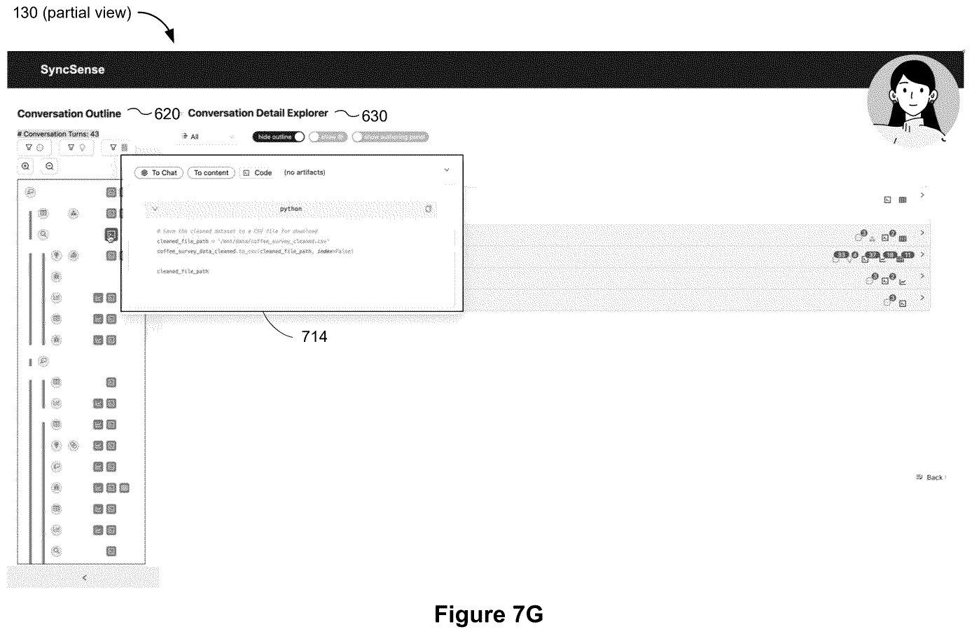

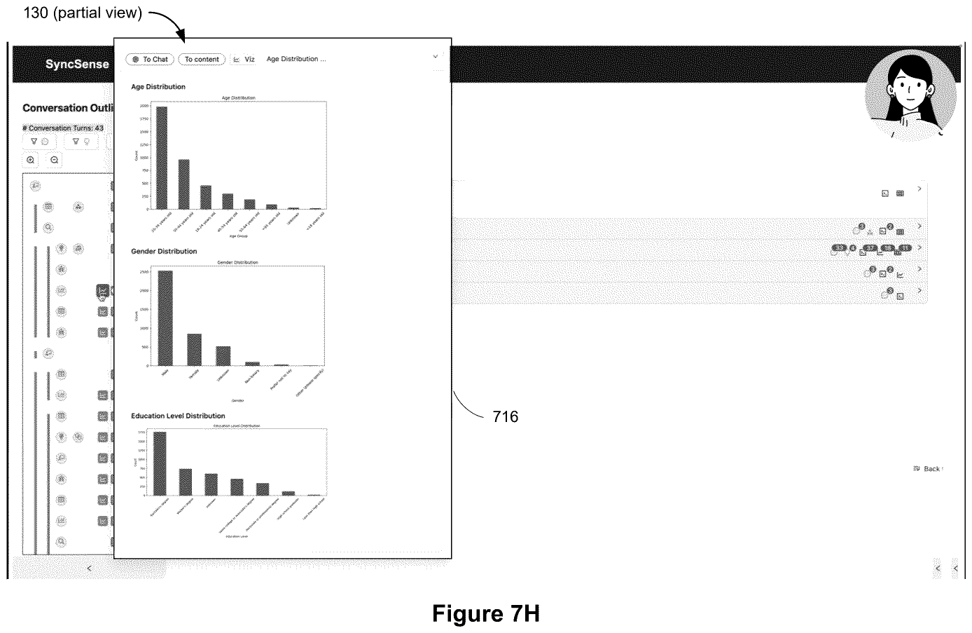

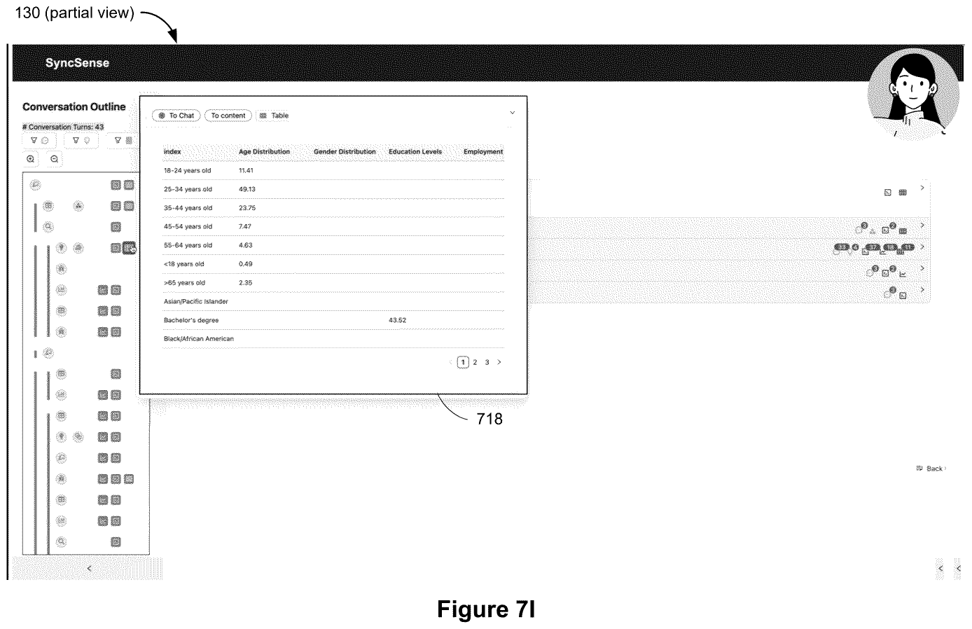

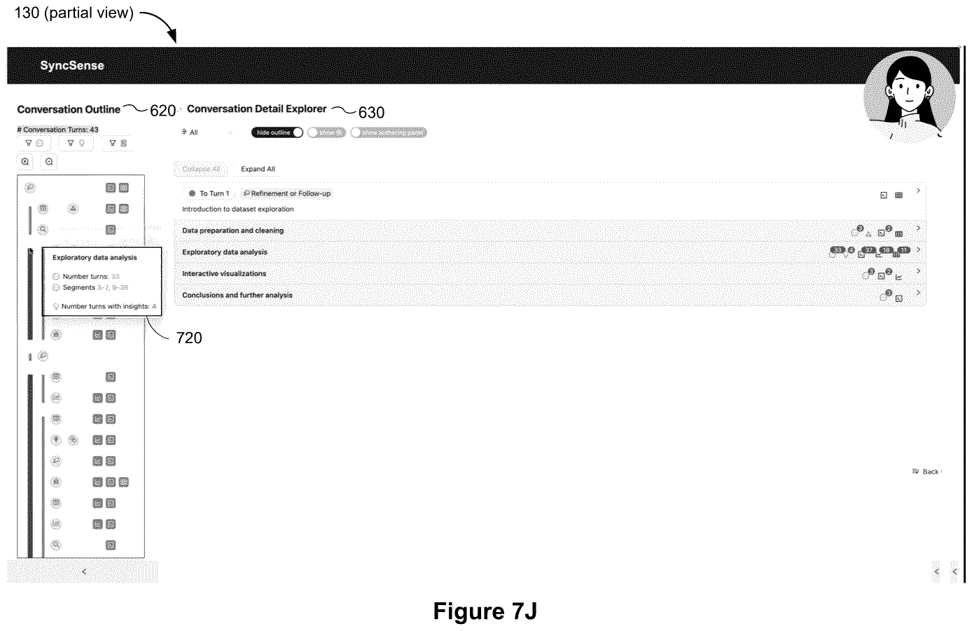

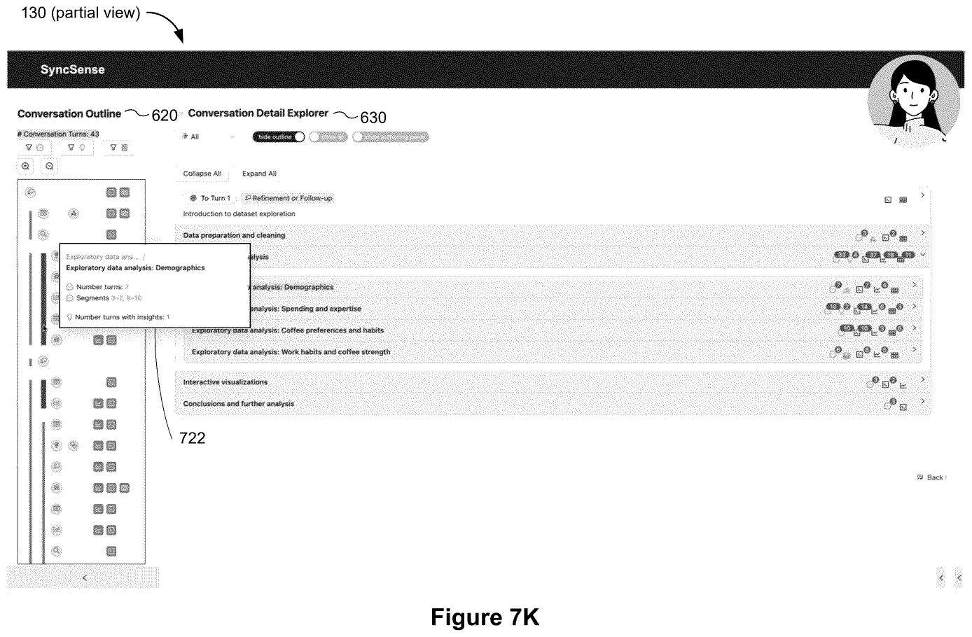

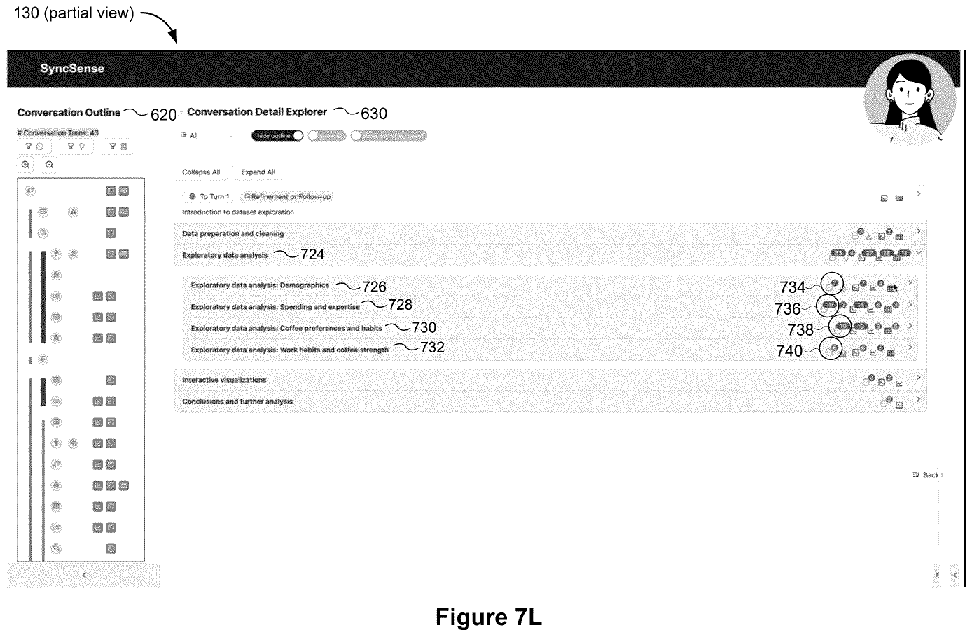

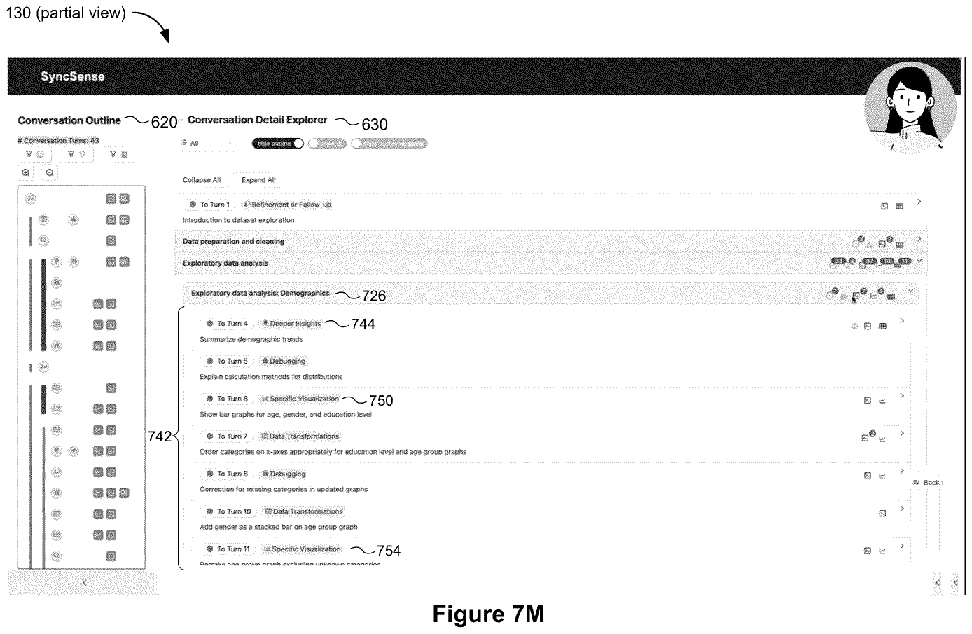

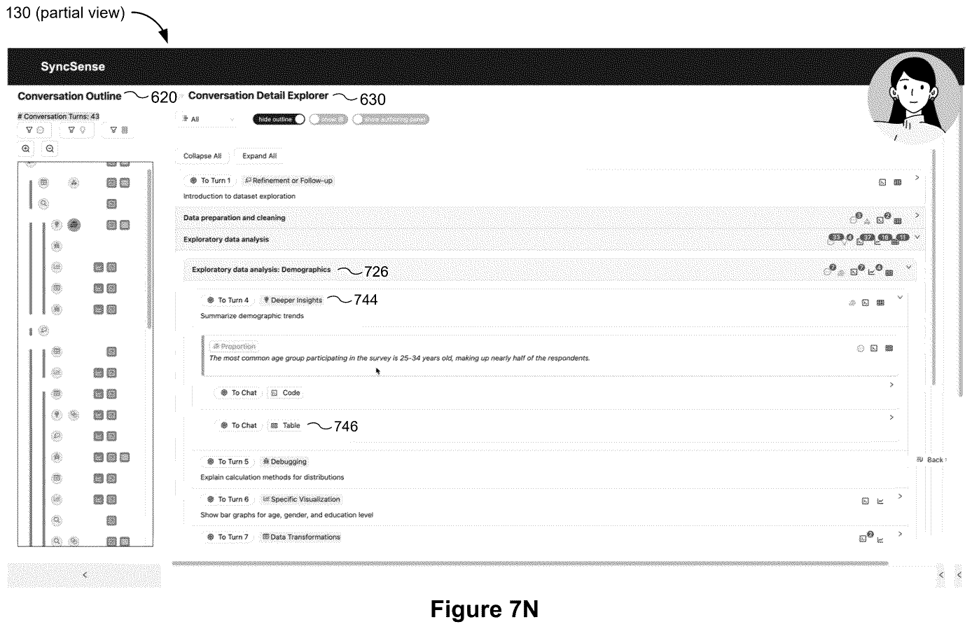

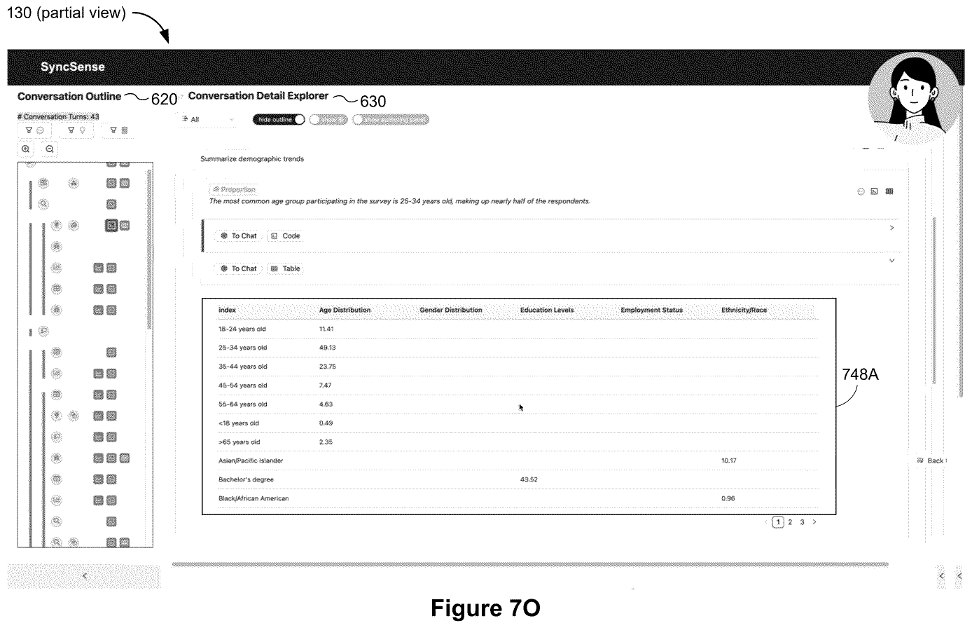

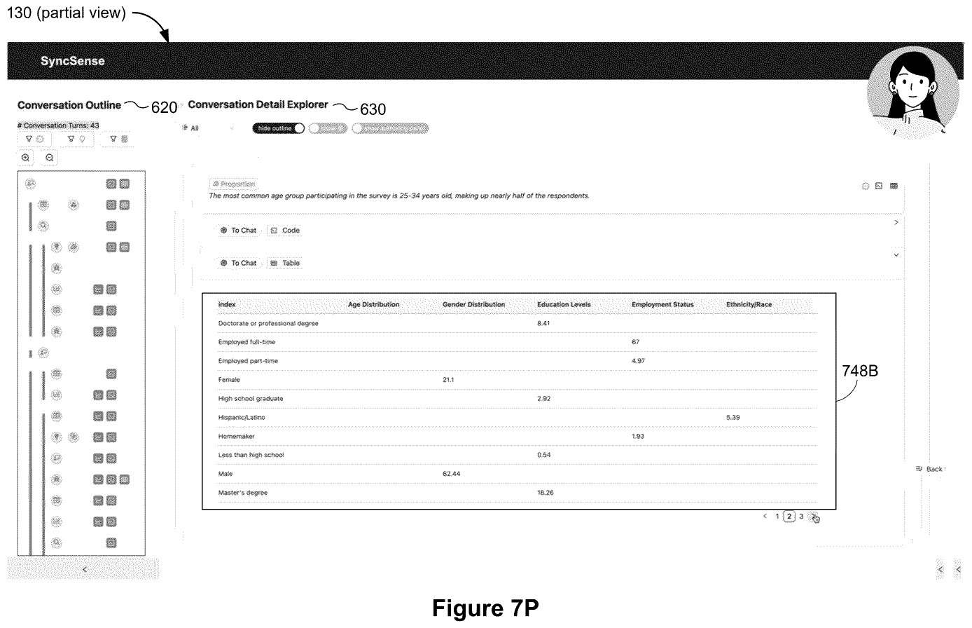

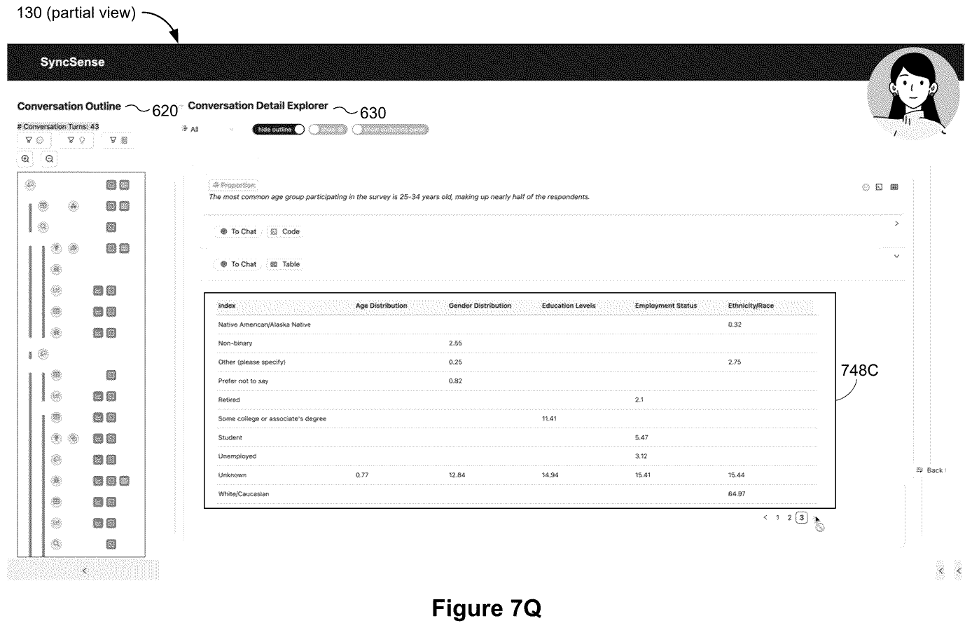

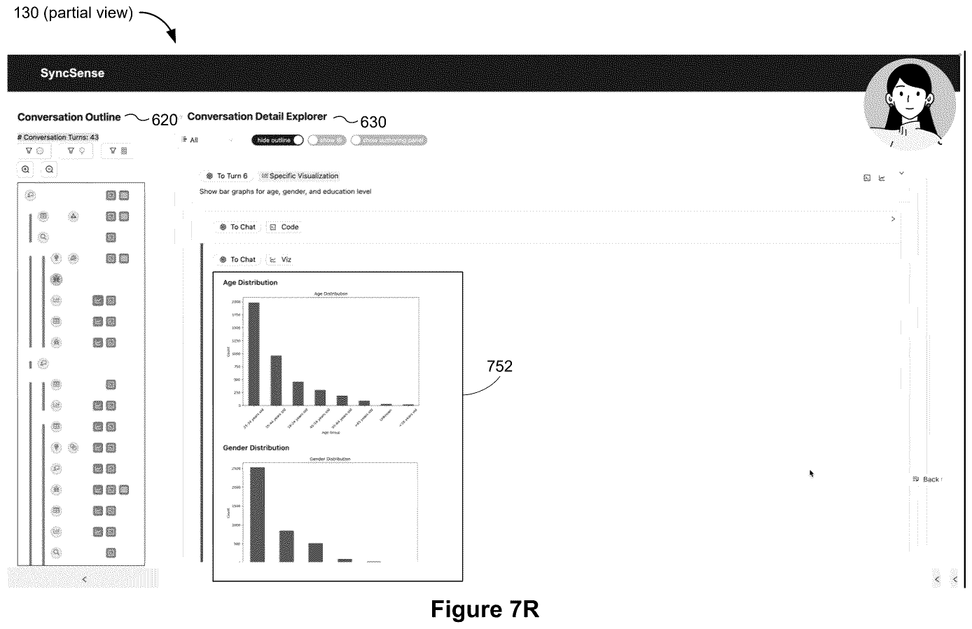

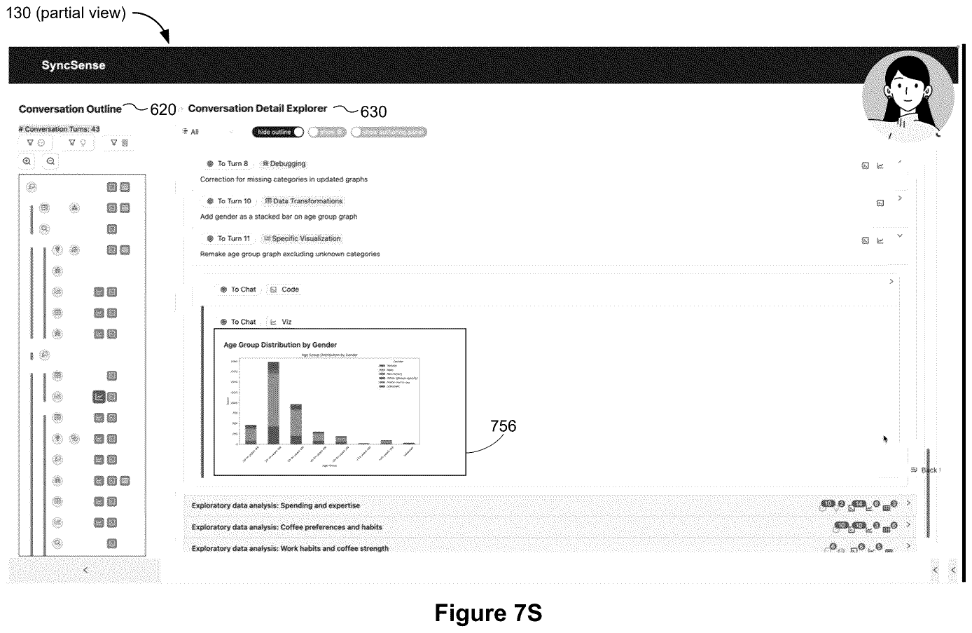

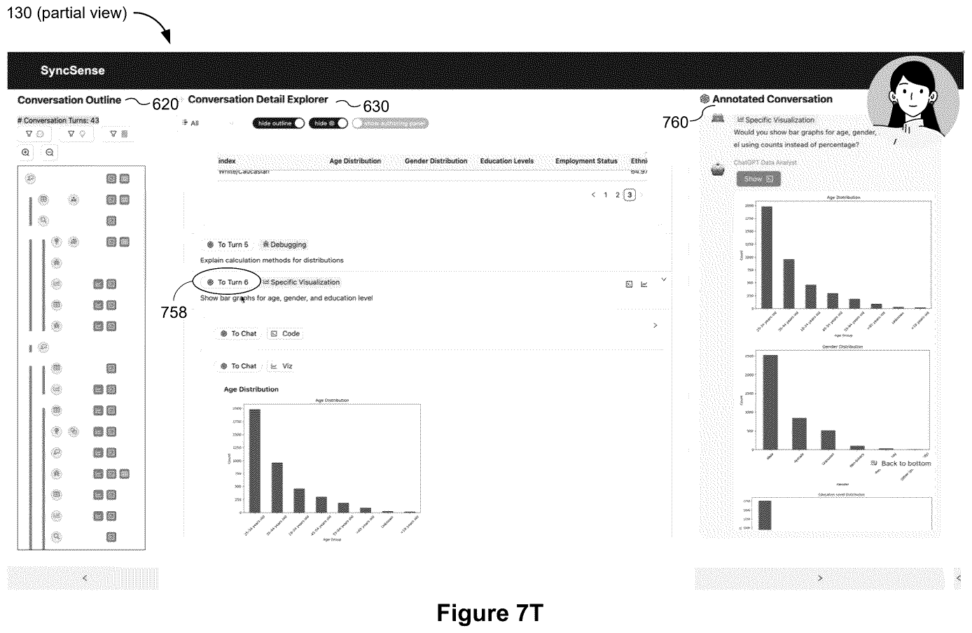

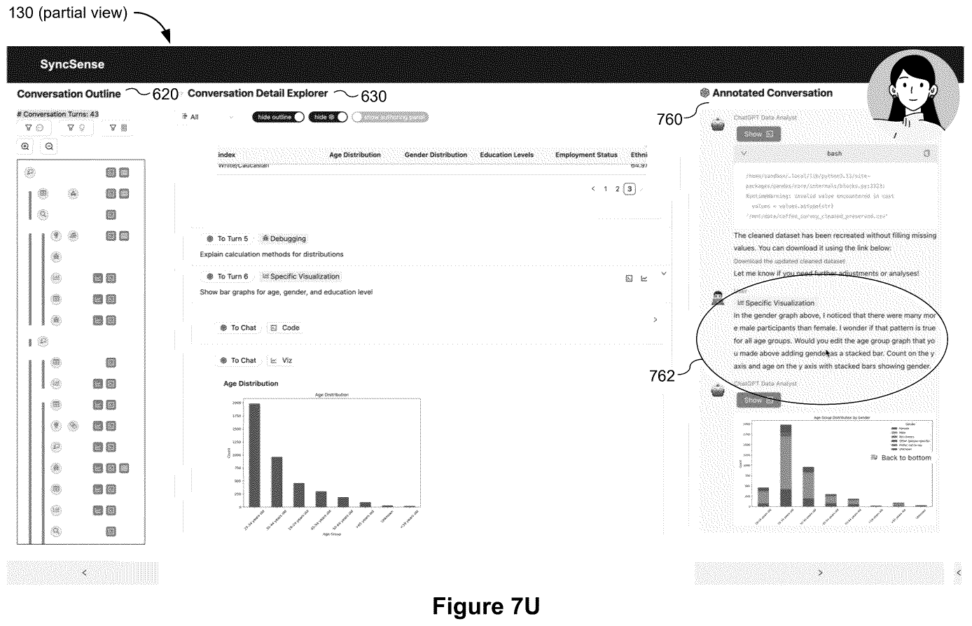

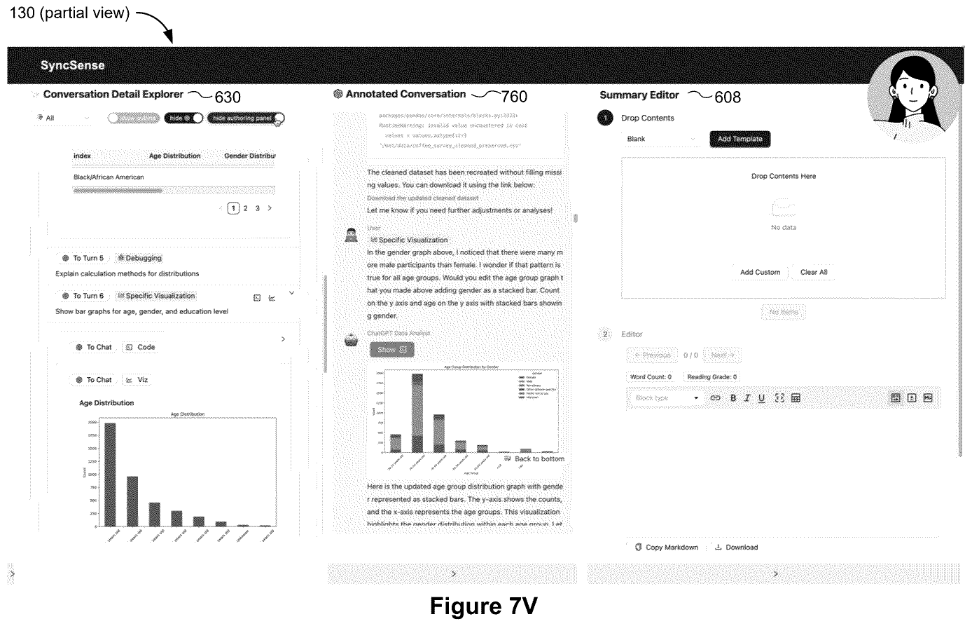

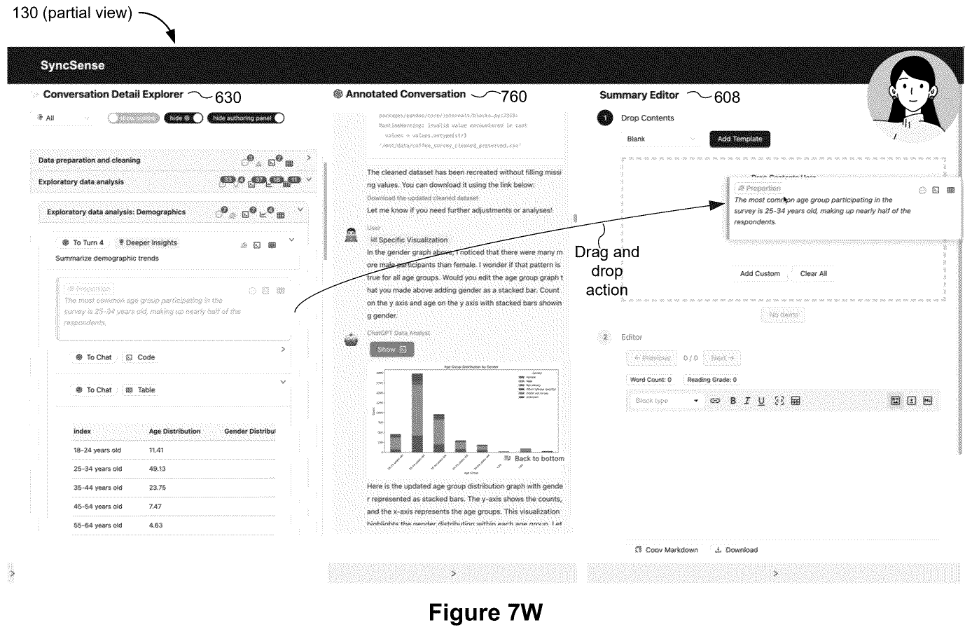

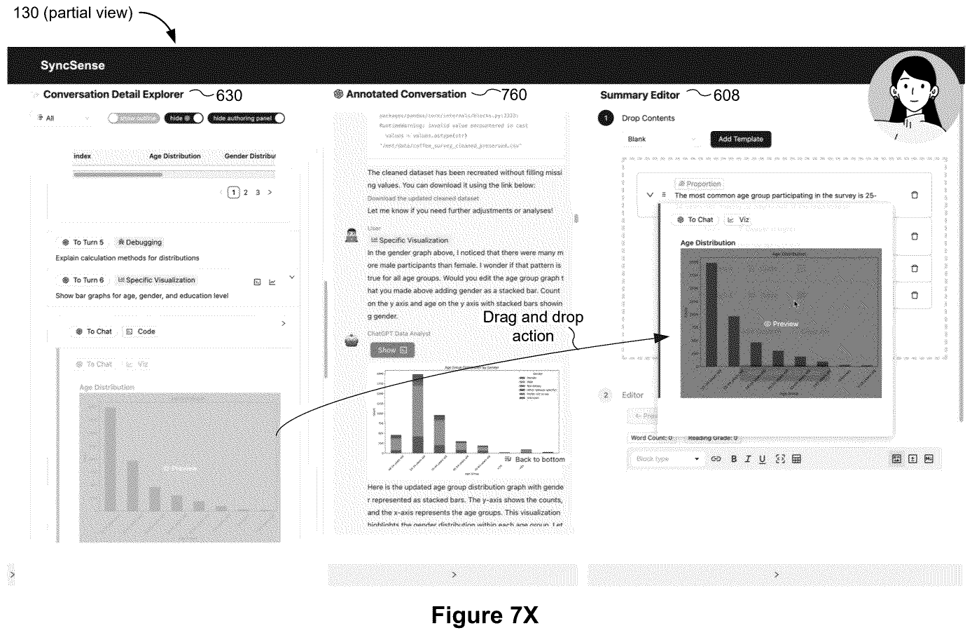

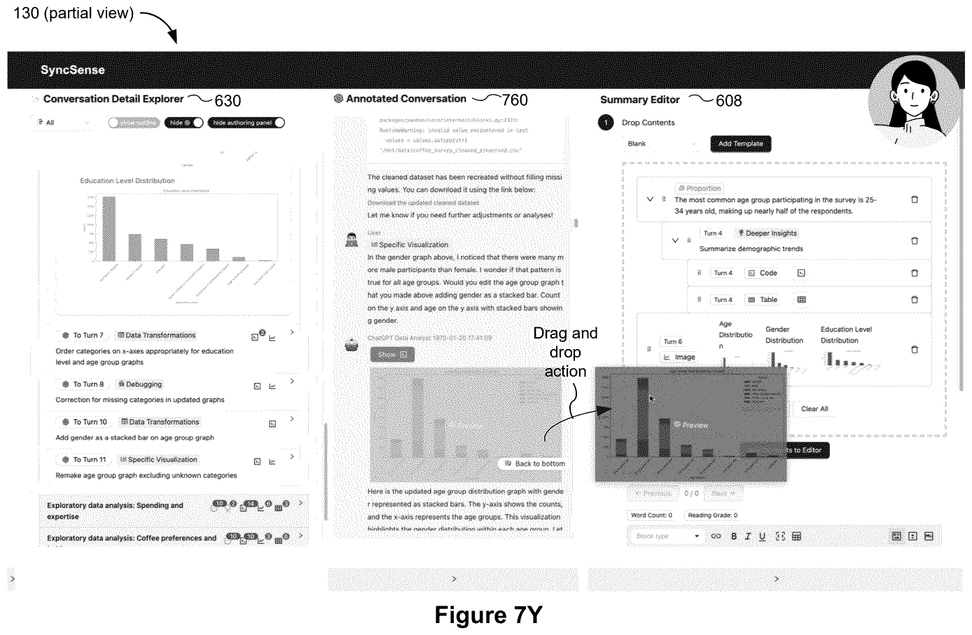

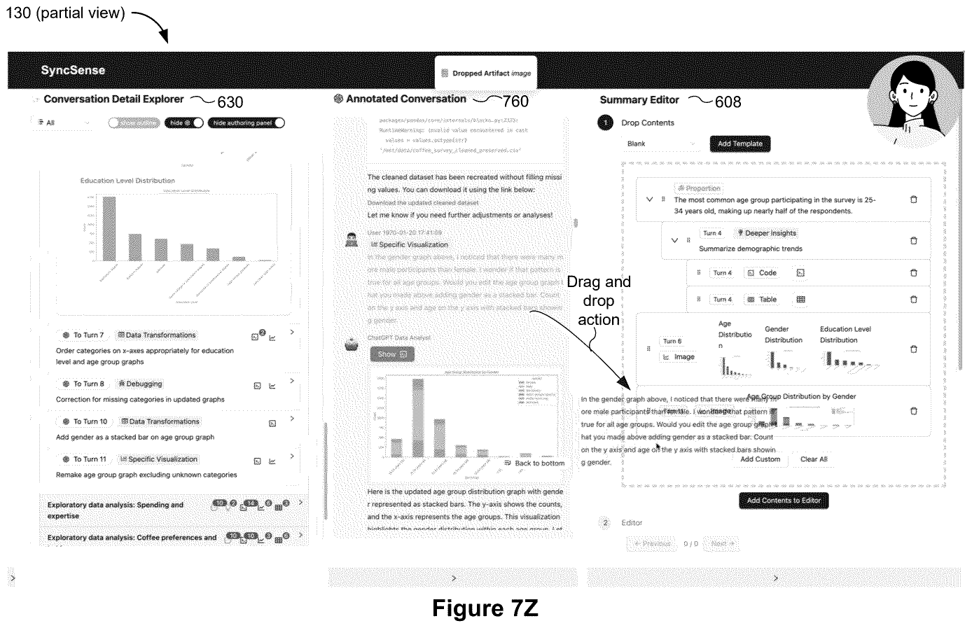

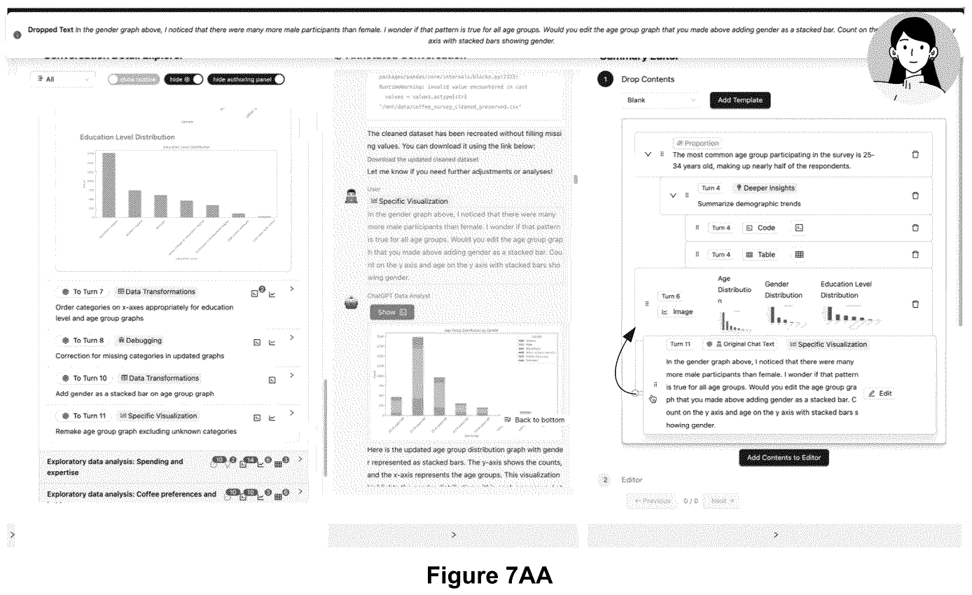

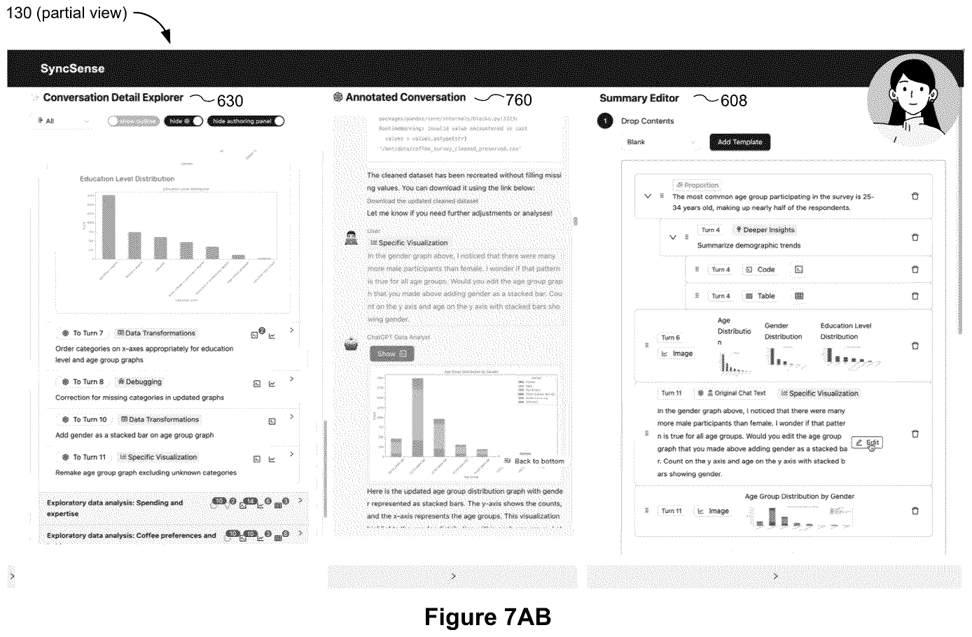

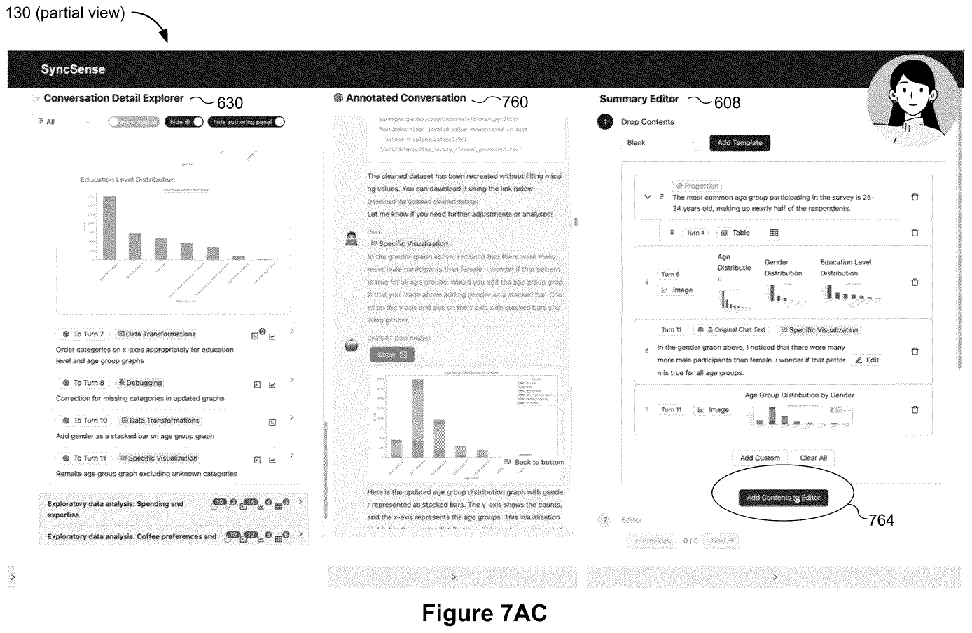

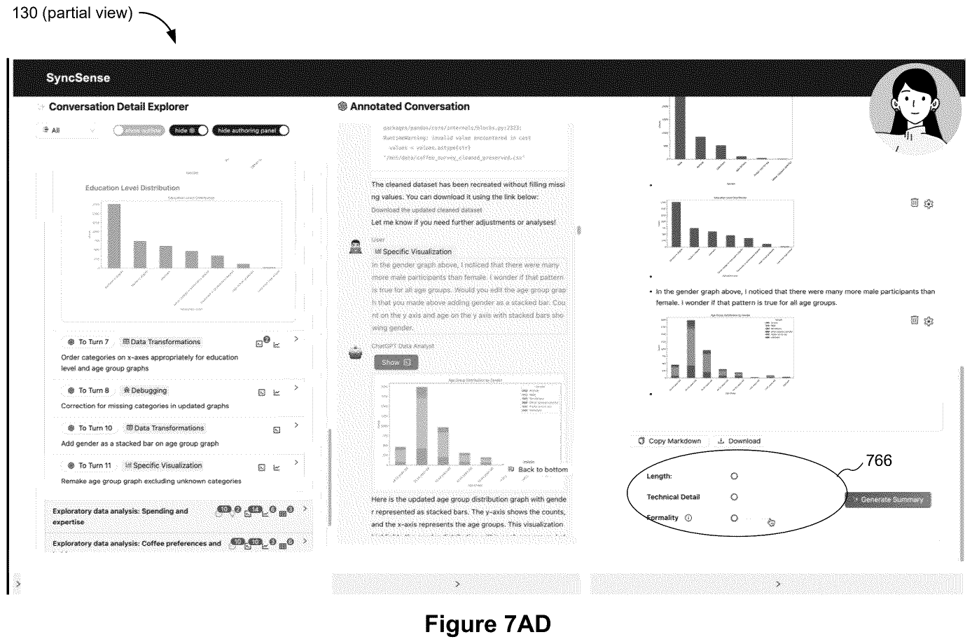

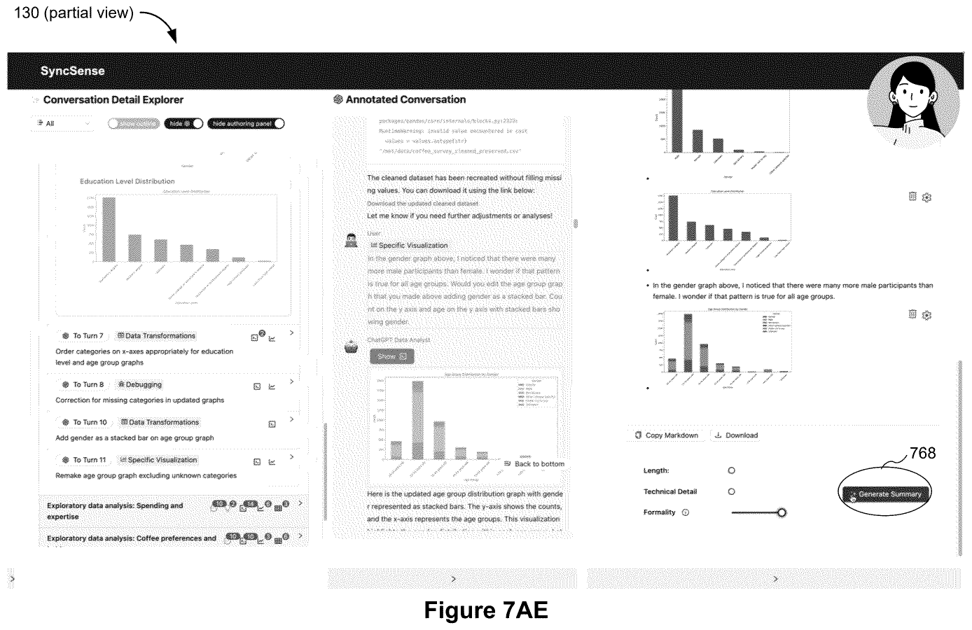

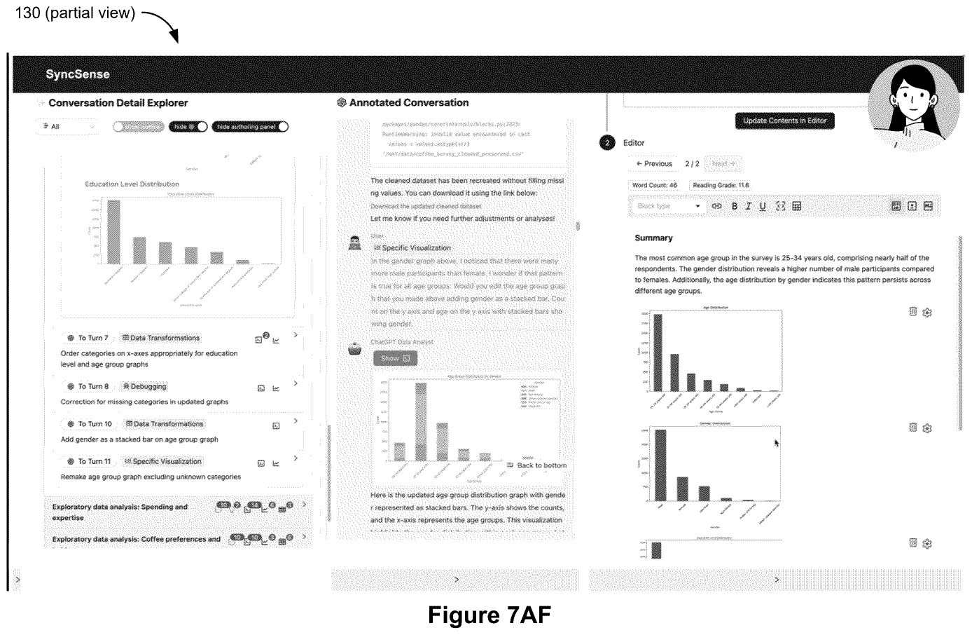

FIGS. 7A to 7AG are screenshots illustrating user interactions with SyncSense, in accordance with some embodiments. Having introduced the key features of the authoring interface, FIGS. 7A to 7AG are screenshots presenting a walkthrough that illustrates how a user might interact with SyncSense to analyze and summarize an analytical conversation in practice. Additional examples of user interactions with SyncSense are also described in U.S. patent application Ser. No. 19/019,351, filed Jan. 13, 2025, the contents of which are incorporated by reference herein in its entirety.

Large Language Models (LLMs) are transforming how people analyze data. With LLM-based or Chatbot-based interfaces such as ChatGPT, Microsoft Copilot, and Tableau Agent, it is now increasingly popular and accessible to explore data by simply having a “conversation” with an LLM. But once the conversation ends, what remains is a static, linear, and often long, messy log—full of back-and-forths as a data worker debugs, rephrases prompts, and refines their analysis—interwoven with explanations, charts, tables, and code Consider a user Zoe, a data analyst who wants to open a cafe in her city. To make informed data-driven decisions, Zoe analyzed a recent coffee survey dataset, which surveyed 4,000 coffee drinkers across America and contains rich data on their coffee taste preferences and demographic information. She wants to summarize her analytical conversation in an email to send to an investor. Because the investor is nontechnical, Zoe wants to share the highest level overview of her main insights. To answer her investor/marketing team, she goes back through her analysis with the AI chatbot (e.g., in ChatGPT). There is a lot of information here, and it all looks relevant. She has trouble finding specific insights, visualizations and data tables that she created during her analysis. She has to go through the entire conversation, line by line, to recall the overview of what she did, and she has to scroll back and forth to extract specific relevant parts to send. To craft her response, she would like to add her own notes to highlight key takeaways, shorten the length to fit a concise message, lower the technical detail of the analysis, and adjust the formality to make it more friendly.

FIGS. 7A to 7AG demonstrate how SyncSense can help data workers like Zoe share their analytical reasoning and insights with their target audience

In FIG. 7A, user Zoe inputs a link 702 corresponding to her analytical conversation with ChatGPT, and uploads the coffee dataset 704, onto a computer system executing SyncSense. In accordance with receiving the link 702 and the dataset 704, SyncSense automatically extracts the structure of the analytical conversation, breaking it into visual, interactive layers of detail. FIG. 7B depicts user interface 130 displaying Conversation Outline panel 620 and Conversation Detail Explorer panel 630 (see also FIG. 6F). The user's analytical conversation is annotated with visual interactive layers of detail in these panels. In this example, because it has been a while since she last explored the chat, Zoe is able to gather a high-level overview of her conversation through these panels.

FIGS. 7C, 7D, 7E, 7F, 7G, 7H, and 7I illustrate example data shown in the Conversation Outline panel 620 and Conversation Detail Explorer panel 630. For example, the Conversation Outline panel 620 provides a high-level map of the conversation with turns, threads, insights, and artifacts, all of which are represented with visual icons. By scrolling and hovering, clicking on threads, and viewing the corresponding thread in the Conversation Detail Explorer panel 630, the user can uncover details about analysis threads, conversation turns, insights, and artifacts, such as a speech act type involving a data transformation 706 in FIG. 7C, a speech act type involving fact finding 708 in FIG. 7D, an insight type involving proportion 710 in FIG. 7E, an insight type involving categorization 712 in FIG. 7F, an analysis artifact that includes code 714 in FIG. 7G, an analysis artifact that includes visualizations 716 in FIG. 7H, and an analysis artifact that includes a data table 718 in FIG. 7I.

FIG. 7J shows that when the user interacts with one of the visual icons (e.g., by clicking on or hovering over the icon), a window 720 is displayed in the user interface. The contents of the window 720 reveal that a majority of the user's conversations (33/43 turns) were focused on exploratory data analysis, of which 7 are around demographics, as shown in window 722 in FIG. 7K. The Conversation Detail Explorer panel 630 can also provide a breakdown of the user's conversations. For example, FIG. 7L shows that the user's conversations on exploratory data analysis 724 can be further subdivided into demographics thread 726 with 7 turns, indicated by the number “7” next to icon 734; spending and expertise thread 728 with 10 turns, indicated by the number “10” next to icon 736; coffee preferences and habits thread 730 with 10 turns, indicated by the number “10” next to icon 738; and work habits and coffee strength thread 732 with 6 turns, indicated by the number “6” next to icon 740.

In FIG. 7M, the user clicks into the Demographics thread 726 and drills down into the Conversation Detail Explorer panel 630. Here, the user interface 130 displays a list 742 of turns, insights, and artifacts like charts and tables. On the list 742 is an extracted insight 744 (e.g., “Deeper insights”) from conversational turn 4. To examine it further, the user can expand turn 4 (e.g., by clicking on extracted insight 744) as shown in FIG. 7N, and also opens a corresponding table 748A, 748B, and 748C in FIGS. 70, 7P, and 7Q (e.g., by clicking on the “Table” icon 746 in FIG. 7N), which allows the user to understand how the insight was derived.

Referring back to the list 742 in FIG. 7M, the user sees that in turn 6, she had requested specific visualizations 750 related to age, gender, and education-level demographics. Expanding these turns, she finds, as illustrated in FIG. 7R, a set of visualizations 752 providing different demographic breakdowns. FIG. 7M also shows that in turn 11, the user had requested a visualization 754 depicting gender distribution across age groups. FIG. 7S shows that when turn 11 is expanded, the user interface 130 shows a visualization 756 of gender distribution across age groups

Referring to FIG. 7T, in some embodiments, to understand the full context of these artifacts, the user can select the “To Turn” button 758, which opens up the annotated conversation panel 760 (e.g., original chat 606). In FIG. 7U, the user notices in the annotated conversation panel 760 that in one of her follow-up prompts 762, she had noted a significant gender imbalance among participants, helping her recall why a follow-up visualization on age distribution by gender was generated.

Confident after orienting herself with the conversation and prioritizing relevant items, the user begins crafting her summary. In FIG. 7V, the user opens the Summary editor panel 608 in the user interface 130, and simply drags the relevant insights, charts, and/or supporting explanation from respective panels, such as the Conversaton Detail Explorer panel 630 and the Annotated Conversation panel 760, into the Summary editor panel 608, as depicted in FIGS. 7W, 7X, 7Y, and 7Z. FIG. 7AA and 7AB show that the user can rearrange the content, make minor edits, and serialize it to markdown. In FIG. 7AC, the contents are added to the editor (e.g., by selecting the “Add contents to editor” icon 764).

To tailor the tone to the target audience, the user can SyncSense's sliders 766 shown in FIG. 7AD to generate an updated summary by making it longer or shorter, removing technical jargon, and/or making the tone semi-formal. In FIG. 7AE, the user selects the “Generate summary” icon 768 to generate the summary. FIG. 7AF and 7AG show the user can review the results and copy the summary, and send the summary. SyncSense enables the user to re-find what mattered, see the story behind each insight, and share her analysis with clarity, context, and authorship. In summary, SyncSense brings structure to analytical conversations—helping data workers navigate, make sense of, and communicate their findings more effectively. By organizing conversations into threads, insights, and artifacts, SyncSense supports effective sensemaking and communication of messy analytical conversations.

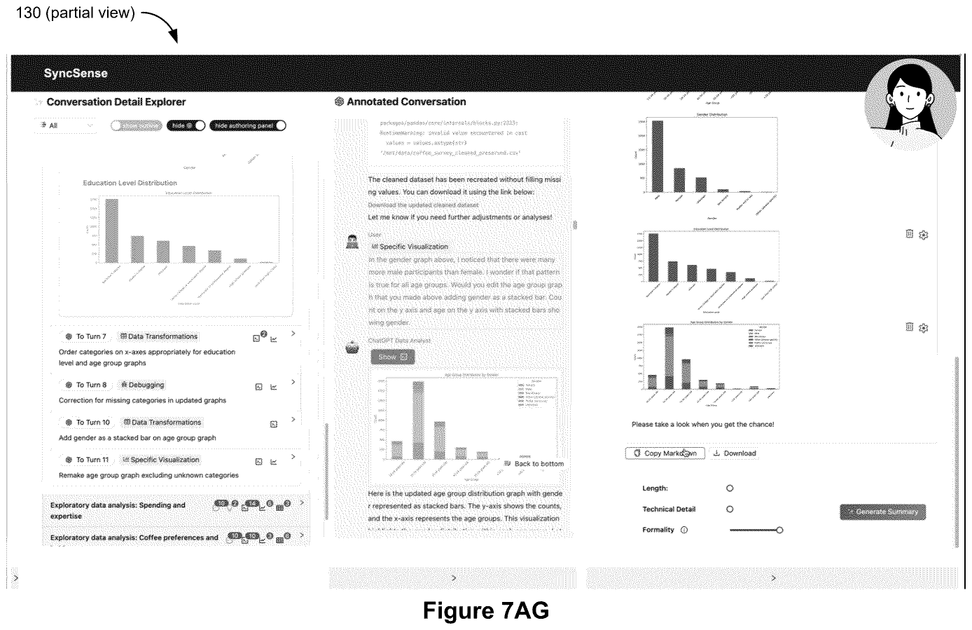

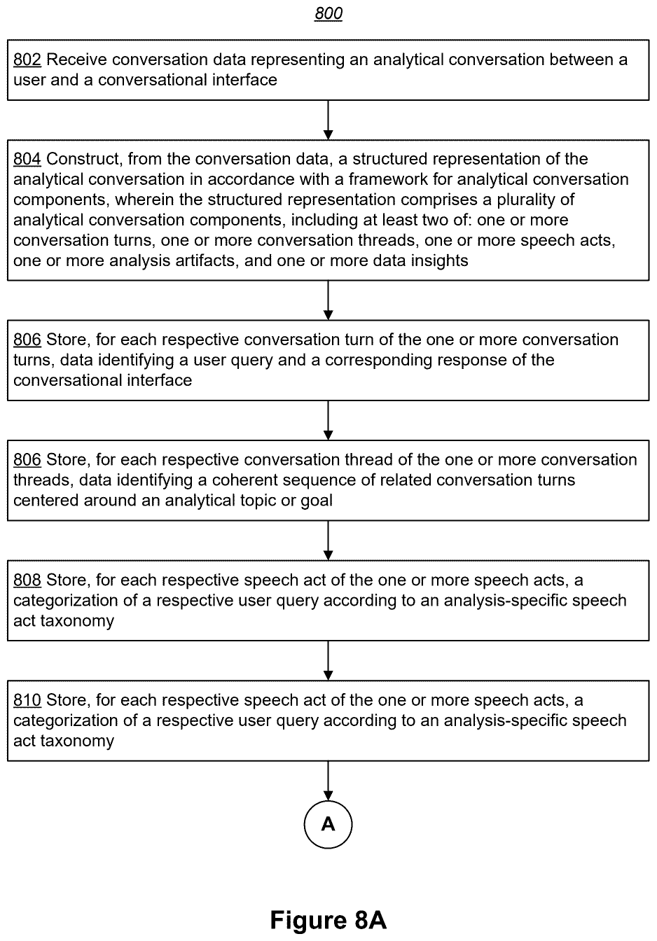

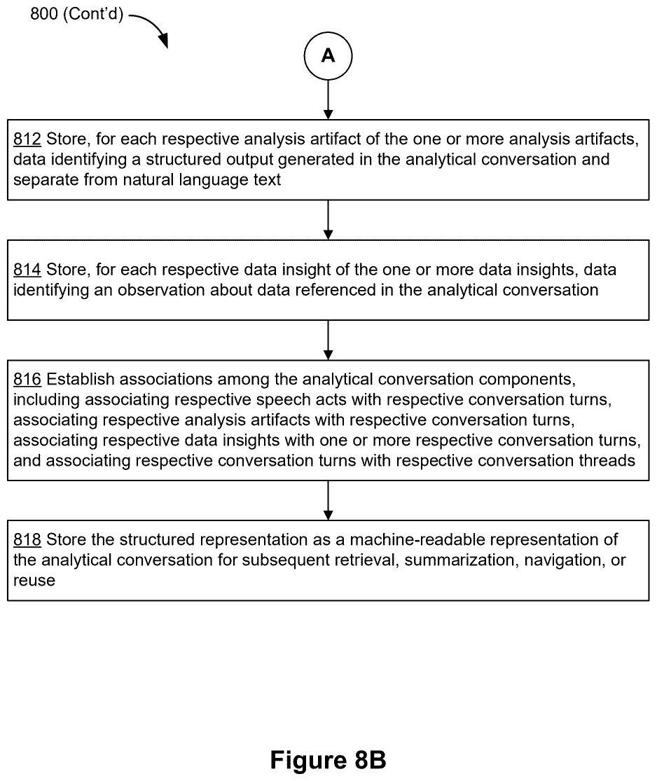

FIGS. 8A and 8B provide a flowchart of an example process for generating machine-readable representations of analytical conversations, in accordance with some embodiments. The method 800 is performed at a computer system (e.g., computing device 200 or computer system 300) that includes one or more processors (e.g., processor(s) 202 or processor(s) 302, and memory (e.g., memory 206 or memory 314). The memory stores one or more programs configured for execution by the one or more processors. In some embodiments, the operations shown in FIGS. 1, 4, 5, 6A-6G, and 7A to 7AG correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 800 may be combined and/or the order of some operations may be changed.

Referring to FIG. 8A, in step 802, the computer system receives conversation data (e.g., chat history 108 and dataset 110; or link 702 corresponding to a user's analytical conversation with ChatGPT and dataset 704) representing an analytical conversation between a user and a conversational interface. In accordance with some embodiments, receiving conversation data representing an analytical conversation between a user and a conversational interface allows the computer system to operate on the underlying conversation history, including the prompt-and-response exchanges and/or associated analytical content such as code or other structured materials. This step enables the conversation to be processed as an input for later organization, so that the analysis can be revisited, summarized, navigated, or reused from the recorded conversation data rather than only from a linear transcript view.

In step 804, the computer system constructs (e.g., using content extraction module 232 or content extraction module 332), from the conversation data, a structured representation of the analytical conversation in accordance with a framework for analytical conversation components (see, e.g., section on “Framework for Analytical Conversation Components” described above). The structured representation comprises a plurality of analytical conversation components, including at least two of: one or more conversation turns, one or more conversation threads, one or more speech acts, one or more analysis artifacts, and one or more data insights. Constructing, from the conversation data, the structured representation in accordance with a framework of analytical conversation components allows the conversation to be organized into turns, threads, speech acts, analysis artifacts, and data insights. This arrangement enables long analytical exchanges to be represented in a machine-readable form that supports navigation at different abstraction levels, recovery of analytical context, and more targeted access to portions of the conversation than approaches that leave the conversation as an undifferentiated log.

In step 806, the computer system stores, for each respective conversation turn (e.g., prompt-response pairs) of the one or more conversation turns (e.g., as conversation turn data 235A or conversation turn data 362), data identifying a user query and a corresponding response of the conversational interface. Storing, for each conversation turn, data identifying a user query and a corresponding response of the conversational interface allows each prompt-response exchange to remain available as an explicit unit within the structured representation. This step enables later retrieval of the original local context for a particular analytical step, supports tracing of how a result was produced, and provides an anchor for associated components such as speech acts, artifacts, and insights.

In step 808, the computer system stores, for each respective conversation thread (e.g., coherent analytical sub-conversations, including nested sub-threads) of the one or more conversation threads (e.g., as conversation turn thread 235B or conversation thread data 364), data identifying a coherent sequence of related conversation turns centered around an analytical topic or goal. Storing, for each conversation thread, data identifying a coherent sequence of related conversation turns centered around an analytical topic or goal allows related portions of the conversation to be grouped according to subject matter or analytical objective. This step enables post-hoc exploration of the conversation by topic, including in nested or multi-level thread structures in some embodiments, thereby reducing the need to manually traverse a full chronological history when revisiting a particular line of analysis.

In step 810, the computer system stores, for each respective speech act of the one or more speech acts (e.g., as speech act data 235C or speech act data 366), a categorization of a respective user query according to an analysis-specific speech act taxonomy. For example, speech acts categorize the user's analytical intent, such as fact finding, deep insights, specific visualization, data transformations, refinement, recommendation, domain knowledge, and debugging. Storing, for each speech act, a categorization of a respective user query according to an analysis-specific speech act taxonomy allows the system to preserve the analytical intent associated with the user query. This step enables intent-based filtering, visual differentiation, and retrieval of conversation portions according to functions such as fact finding, refinement, recommendation, or debugging, which helps organize analytical interactions by purpose instead of only by sequence.

Referring to FIG. 8B, in steps 812, the computer system stores, for each respective analysis artifact of the one or more analysis artifacts (e.g., as analysis artifact data 235D or analysis artifact data 368), data identifying a structured output generated in the analytical conversation and separate from natural language text. As described above, analysis artifacts can include outputs such as visualizations, data tables, and code. Storing, for each analysis artifact, data identifying a structured output generated in the analytical conversation and separate from natural language text allows outputs such as visualizations, data tables, code, or execution results to be represented as distinct components of the conversation. This step enables those non-text outputs to be located, reopened, and associated with their originating conversational context, which supports later review, verification, and reuse of analytical outputs that might otherwise remain embedded within a longer exchange.

In step 814, the computer system stores, for each respective data insight of the one or more data insights (e.g., as data insight data 235E or data insight data 370), data identifying an observation about data referenced in the analytical conversation. For example, insights are meaningful observations about the data and are classified using an insight taxonomy including value, proportion, difference, distribution, trend, rank, aggregation, association, extreme, categorization, and outlier. Storing, for each data insight, data identifying an observation about data referenced in the analytical conversation allows meaningful observations to be preserved as discrete components rather than remaining buried within free-form dialogue. This step enables efficient retrieval and reuse of the substantive analytical conclusions of the conversation, while also supporting access to the associated turns and, in some embodiments, related artifacts that provide context for how the observation was derived.

In step 816, the computer system establishes (e.g., via via association/provenance data 235F or association/provenance data 372) associations among the analytical conversation components, including associating respective speech acts with respective conversation turns, associating respective analysis artifacts with respective conversation turns, associating respective data insights with one or more respective conversation turns, and associating respective conversation turns with respective conversation threads. Establishing associations among the analytical conversation components, including associations between speech acts and turns, artifacts and turns, insights and one or more turns, and turns and threads, allows the structured representation to preserve relationships among the different elements of the analytical conversation. SyncSense preserves provenance so summary components retain a link back to original context. This step enables synchronized navigation across component types, supports provenance-preserving access from a higher-level item to its underlying conversational context, and helps a user understand how a given insight, artifact, or analytical objective relates to specific portions of the conversation.

In some embodiments, the associations among turns, threads, speech acts, artifacts, and insights are stored as explicit machine-readable links, mappings, or indexes that enable bidirectional navigation among the different component types. For example, selection of an insight in one interface region can cause the system to retrieve, using one or more stored identifiers, the associated turn or turns from which the insight was derived and to present the associated artifact, thread, or source conversation content in another interface region. This linkage allows the system to preserve provenance between higher-level analytical outputs and underlying conversational context in a manner that improves traceability, verification, and contextual recovery within the computer interface

In step 818, the computer system stores (e.g., as conversational components 233 or in the database 350) the structured representation as a machine-readable representation of the analytical conversation for subsequent retrieval, summarization, navigation, or reuse. Storing the structured representation as a machine-readable representation of the analytical conversation for subsequent retrieval, summarization, navigation, or reuse allows the conversation to be retained in a form that can drive downstream operations beyond the original chat session. This step enables component-based retrieval, structured summarization, selective communication of analysis results, and reuse of prior analytical work from the stored representation, instead of requiring repeated manual review of a static conversation history.

In some embodiments, the machine-readable representation of the analytical conversation is not merely a transcript or summary, but a computer-usable data structure that stores a plurality of typed conversation components as distinct addressable objects in memory. For example, the computer system can store, for each conversation turn, a turn identifier, a user-query field, a response field, and one or more links to related threads, speech acts, artifacts, and insights. The computer system can further store, for each thread, a thread identifier and one or more references to associated turns and, in some embodiments, parent-child relationships between threads and sub-threads. By storing the analytical conversation in this form, the system supports component-addressable retrieval and processing of the conversation contents without repeatedly traversing a linear conversation log.

In some embodiments, the structured representation is used to drive synchronized updates across multiple interface views that correspond to different abstraction levels of the analytical conversation. For example, a user interaction with a thread-level representation, an insight-level representation, an artifact-level representation, or a turn-level representation can trigger coordinated rendering operations in one or more other panels of the interface so that related content is surfaced without requiring manual searching through the full chat history. This coordinated presentation enables the computer system to provide context-sensitive navigation of long analytical conversations that include interleaved topics, generated outputs, and supporting explanations.

In some embodiments, analysis artifacts are stored separately from natural-language conversation text and are maintained with metadata sufficient to permit later retrieval, rendering, or regeneration. Example analysis artifacts include code, tables, visualizations, and execution outputs generated during the analytical conversation. In some embodiments, the computer system stores an artifact identifier, an artifact type, a source-turn reference, and one or more locations of corresponding artifact content. Separating such artifacts from the natural-language transcript enables the system to selectively retrieve and present non-text analytical outputs that may otherwise be difficult to identify or recover from a raw conversation history.

In some embodiments, when the analytical conversation includes executable analytical content, the computer system processes that content in a controlled execution environment and stores resulting outputs as analysis artifacts associated with the originating conversation turn. For example, code included in a conversational exchange can be executed in a sandboxed environment having a defined software configuration so that generated tables, visualizations, or other outputs are reproducible and can be re-associated with the analytical conversation. This arrangement allows the computer system to preserve computationally generated outputs as part of the structured representation rather than treating the conversation as unstructured text.

In some embodiments, the computer system applies one or more extraction modules (e.g., content extraction module 232/332) to derive one or more of the threads, speech acts, artifacts, or insights from received conversation data and then stores the extracted components in the structured representation for later interface rendering and retrieval. The extracted components can be updated, refined, or corrected, and the corresponding associations can be revised in response to user input or additional processing. This allows the computer system to maintain a persistent and updatable analytical-conversation model that supports later summarization, navigation, and reuse.

In some embodiments, the structured representation improves operation of a computer-based analytical interface by enabling retrieval according to component type, analytical topic, or associated source turn, rather than limiting access to chronological transcript review. For example, the computer system can retrieve only insights, only artifacts, only turns associated with a selected thread, or only content associated with a selected speech act, and can render the retrieved content in corresponding interface regions. This selective retrieval reduces reliance on manual scrolling through conversation history and permits the interface to present analytical content in forms better suited to post-hoc review, verification, and communication.

In some embodiments, the stored component structure further supports generation of downstream outputs by enabling the computer system to assemble selected conversation components into a separate machine-readable authoring input, such as markdown or another structured document representation, while preserving references to source conversation content. Because the system operates on typed components and stored associations rather than only on free-form transcript text, the resulting downstream output can incorporate selected insights, artifacts, and explanatory context with improved attribution to the originating analytical conversation.

In some embodiments, the computer system can maintain one or more indexes, caches, or lookup structures for the stored conversation components and associations so as to support responsive retrieval and rendering of selected portions of the analytical conversation. For example, the system can maintain indexes keyed by component type, thread identifier, turn identifier, insight type, artifact type, or speech act category. Such indexes enable the system to respond to filtering, expansion, and navigation requests by retrieving corresponding subsets of the analytical conversation structure from memory or storage without reprocessing the entire conversation history.

In some embodiments, the structured representation can be stored as a graph structure, hierarchical structure, relational structure, object-based structure, JSON-based structure, or another machine-readable format that preserves component identity and associations among component types. Regardless of the particular storage format, the representation enables the computer system to treat analytical conversation contents as linked computational objects that can be queried, filtered, rendered, and reused by downstream software components.

In some embodiments, after the structured representation has been stored as the machine-readable representation, the computer system (e.g., via component retrieval module 238 or component retrieval module 335) receives a user interaction identifying a selected analytical conversation component of the machine-readable representation. In response to receiving the user interaction, the computer system retrieves from the machine-readable representation one or more additional analytical conversation components associated with the selected analytical conversation component based on the established associations; and causes information corresponding to the selected analytical conversation component and the one or more additional analytical conversation components to be displayed in a user interface (E.g., user interface 130). In some embodiments, the displayed information is presented in one or more coordinated interface regions so that selection of one component causes related components to be surfaced without requiring manual review of a chronological transcript, as illustrated in FIGS. 6D to 6F and FIGS. 7J to 7U.

In some embodiments, the selected analytical conversation component is a selected conversation thread. In some embodiments, retrieving the one or more additional analytical conversation components includes retrieving one or more conversation turns associated with the selected conversation thread. For instance, in FIGS. 7L to 7N a user can drill into the demographics thread and the system displays associated turns and related content. Because a conversation thread corresponds to a coherent sequence of related conversation turns centered around an analytical topic or goal, retrieval of the associated conversation turns allows the computer system to expose the localized conversational context corresponding to the selected analytical topic.

In some embodiments, retrieving the one or more additional analytical conversation components further includes retrieving one or more data insights and one or more analysis artifacts associated with the one or more conversation turns associated with the selected conversation thread. Artifacts and insights are separate component types associated with turns and retrievable based on those associations. For example, FIGS. 7M to 7U show that selection of a thread reveals extracted insights and artifacts such as tables and visualizations associated with turns within that thread. In some embodiments, this arrangement allows a selected thread to serve as an entry point for surfacing associated charts, tables, code, execution outputs, and insight statements, as illustrated in FIGS. 6E and 7M to 7U.

In some embodiments, the computer system generates a communication output based on the selected analytical conversation component and the one or more additional analytical conversation components, wherein the communication output comprises at least one of a summary, a report, a slide outline, or a message tailored to a specified audience and level of technical detail (e.g., and stored in communication output store 378). For example, the system enables selective extraction and arrangement of structured components to generate audience-specific communications, including summaries at different levels of detail. In some embodiments, selected conversation threads, turns, insights, artifacts, or supporting explanation are arranged and serialized for generation of the communication output, as illustrated in FIGS. 6G and 7V to 7AC.

In some embodiments, the computer system stores at least some conversation threads as nested conversation threads within parent conversation threads. In some embodiments, a leaf conversation thread includes two or more conversation turns that are non-consecutive within the analytical conversation. As described above, a thread can contain sub-threads and/or turns, nested threads can provide different abstraction levels within a conversation, and a leaf thread can include multiple non-consecutive turns grouped according to a shared analytical topic or goal rather than strict chronological adjacency.

In some embodiments, the analysis-specific speech act taxonomy includes fact finding, deep insights, visualization requests, data transformations, refinement, recommendation, domain knowledge, and debugging. This is illustrated in FIG. 4.

In some embodiments, the structured output (e.g., analysis artifact, or generated artifacts 124) comprises a visualization, a data table, code, or an execution output. For example, FIGS. 7G to 7I show code, tables, and visualizations being surfaced and revisited. In some embodiments, the computer system stores such artifact types separately from natural-language conversation text so that the artifacts can be retrieved, rendered, verified, regenerated, and re-associated with corresponding turns and insights.

In some embodiments, the computer system classifies the one or more data insights according to an insight taxonomy including value, proportion, difference, distribution, trend, rank, aggregation, association, extreme, categorization, and outlier. AS described above in FIG. 5, the insight taxonomy defines types of observations about data referenced in the analytical conversation and enables the computer system to preserve, organize, retrieve, and reuse analytical conclusions as discrete components of the structured representation.

In some embodiments, the computer system stores provenance data (e.g., association/provenance data 235F or association/provenance data 372) linking a respective data insight to at least one conversation turn and at least one analysis artifact associated with the respective data insight. For example, the stored provenance data preserves links between higher-level analytical outputs and the underlying conversational and computational context from which those outputs were derived, thereby enabling traceability, verification, and context recovery.

In some embodiments, the conversation data further includes executable code and a dataset. The computer system further executes the executable code in a sandboxed environment to regenerate at least one analysis artifact represented in the structured representation. For example, FIG. 1 shows that SyncSense uses a sandboxed Python environment to generate artifacts. Further, as described above, code included in a conversational exchange can be executed in a sandboxed environment having a defined software configuration so that generated tables, visualizations, or other outputs are reproducible and can be re-associated with the analytical conversation.

In some embodiments, the structured representation is stored in a form that preserves both hierarchical relationships among conversation threads and associative relationships among conversation turns, speech acts, analysis artifacts, and data insights. The framework structures the conversation into multiple analytical conversation components and stores associations among them in a machine-readable representation. As described above, association/provenance data 235F or 372 associates respective speech acts with respective conversation turns, associating respective analysis artifacts with respective conversation turns, associating respective data insights with one or more respective conversation turns, and associates respective conversation turns with respective conversation threads. In some embodiments, the machine-readable representation can be maintained as a graph structure, hierarchical structure, relational structure, object-based structure, JSON-based structure, or another machine-readable format that preserves component identity, parent-child thread relationships, and cross-component associations.

In some embodiments, the computer system extracts at least the conversation threads, the speech acts, and the data insights from the conversation data using one or more machine learning models. This is illustrated and explained in, for example, FIG. 1. In some embodiments, extracting the conversation threads includes generating candidate sub-threads and iteratively merging the candidate sub-threads based on similarity. In some embodiments, the one or more machine learning models can include one or more large language models (e.g., LLM(s) 260) configured to extract threads, categorize speech acts, extract and categorize insights, summarize turn pairs, generate candidate sub-threads, and iteratively merge sub-threads according to similarity.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for generating machine-readable representations of analytical conversations, performed at a computer system that includes one or more processors and memory, the method comprising:
receiving conversation data representing an analytical conversation between a user and a conversational interface;
constructing, from the conversation data, a structured representation of the analytical conversation in accordance with a framework for analytical conversation components, wherein the structured representation comprises a plurality of analytical conversation components, including at least two of: one or more conversation turns, one or more conversation threads, one or more speech acts, one or more analysis artifacts, and one or more data insights;
storing, for each respective conversation turn of the one or more conversation turns, data identifying a user query and a corresponding response of the conversational interface;
storing, for each respective conversation thread of the one or more conversation threads, data identifying a coherent sequence of related conversation turns centered around an analytical topic or goal;
storing, for each respective speech act of the one or more speech acts, a categorization of a respective user query according to an analysis-specific speech act taxonomy;
storing, for each respective analysis artifact of the one or more analysis artifacts, data identifying a structured output generated in the analytical conversation and separate from natural language text;
storing, for each respective data insight of the one or more data insights, data identifying an observation about data referenced in the analytical conversation;
establishing associations among the analytical conversation components, including associating respective speech acts with respective conversation turns, associating respective analysis artifacts with respective conversation turns, associating respective data insights with one or more respective conversation turns, and associating respective conversation turns with respective conversation threads; and
storing the structured representation as a machine-readable representation of the analytical conversation for subsequent retrieval, summarization, navigation, or reuse.

2. The method of claim 1, further comprising:
after storing the structured representation as the machine-readable representation, receiving a user interaction identifying a selected analytical conversation component of the machine-readable representation;
in response to receiving the user interaction:
retrieving from the machine-readable representation one or more additional analytical conversation components associated with the selected analytical conversation component based on the established associations; and
causing information corresponding to the selected analytical conversation component and the one or more additional analytical conversation components to be displayed in a user interface.

3. The method of claim 2, wherein:
the selected analytical conversation component is a selected conversation thread; and
retrieving the one or more additional analytical conversation components includes retrieving one or more conversation turns associated with the selected conversation thread.

4. The method of claim 3, wherein retrieving the one or more additional analytical conversation components further includes:
retrieving one or more data insights and one or more analysis artifacts associated with the one or more conversation turns associated with the selected conversation thread.

5. The method of claim 2, further comprising:
generating a communication output based on the selected analytical conversation component and the one or more additional analytical conversation components,
wherein the communication output comprises at least one of a summary, a report, a slide outline, or a message tailored to a specified audience and level of technical detail.

6. The method of claim 1, further comprising storing at least some conversation threads as nested conversation threads within parent conversation threads.

7. The method of claim 6, wherein a leaf conversation thread includes two or more conversation turns that are non-consecutive within the analytical conversation.

8. The method of claim 1, wherein the analysis-specific speech act taxonomy includes fact finding, deep insights, visualization requests, data transformations, refinement, recommendation, domain knowledge, and debugging.

9. The method of claim 1, wherein the structured output comprises a visualization, a data table, code, or an execution output.

10. The method of claim 1, further comprising:
classifying the one or more data insights according to an insight taxonomy including value, proportion, difference, distribution, trend, rank, aggregation, association, extreme, categorization, and outlier.

11. The method of claim 1, further comprising:
storing provenance data linking a respective data insight to at least one conversation turn and at least one analysis artifact associated with the respective data insight.

12. The method of claim 1, wherein:
the conversation data further includes executable code and a dataset; and
the method further comprising executing the executable code in a sandboxed environment to regenerate at least one analysis artifact represented in the structured representation.

13. The method of claim 1, wherein the structured representation is stored in a form that preserves both hierarchical relationships among conversation threads and associative relationships among conversation turns, speech acts, analysis artifacts, and data insights.

14. A computer system, comprising:
one or more processors; and
memory coupled to the one or more processors, the memory storing one or more programs configured to be executed by the one or more processors, the one or more programs including instructions for:
receiving conversation data representing an analytical conversation between a user and a conversational interface;
constructing, from the conversation data, a structured representation of the analytical conversation in accordance with a framework for analytical conversation components, wherein the structured representation comprises a plurality of analytical conversation components, including at least two of: one or more conversation turns, one or more conversation threads, one or more speech acts, one or more analysis artifacts, and one or more data insights;
storing, for each respective conversation turn of the one or more conversation turns, data identifying a user query and a corresponding response of the conversational interface;
storing, for each respective conversation thread of the one or more conversation threads, data identifying a coherent sequence of related conversation turns centered around an analytical topic or goal;
storing, for each respective speech act of the one or more speech acts, a categorization of a respective user query according to an analysis-specific speech act taxonomy;
storing, for each respective analysis artifact of the one or more analysis artifacts, data identifying a structured output generated in the analytical conversation and separate from natural language text;
storing, for each respective data insight of the one or more data insights, data identifying an observation about data referenced in the analytical conversation;
establishing associations among the analytical conversation components, including associating respective speech acts with respective conversation turns, associating respective analysis artifacts with respective conversation turns, associating respective data insights with one or more respective conversation turns, and associating respective conversation turns with respective conversation threads; and
storing the structured representation as a machine-readable representation of the analytical conversation for subsequent retrieval, summarization, navigation, or reuse.

15. The computer system of claim 14, the one or more programs further including instructions for:
extracting at least the conversation threads, the speech acts, and the data insights from the conversation data using one or more machine learning models.

16. The computer system of claim 15, wherein the instructions for extracting the conversation threads include instructions for:
generating candidate sub-threads and iteratively merging the candidate sub-threads based on similarity.

17. The computer system of claim 14, the one or more programs further including instructions for:
classifying the one or more data insights according to an insight taxonomy including value, proportion, difference, distribution, trend, rank, aggregation, association, tail, categorization, and outlier.

18. The computer system of claim 14, the one or more programs further including instructions for:
storing provenance data linking a respective data insight to at least one conversation turn and at least one analysis artifact associated with the respective data insight.

19. The computer system of claim 14, wherein:
the conversation data further includes executable code and a dataset; and
the one or more programs further include instructions for executing the executable code in a sandboxed environment to regenerate at least one analysis artifact represented in the structured representation.

20. A non-transitory computer-readable storage medium storing one or more programs, the one or more programs comprising instructions that, when executed by a computer system, cause the computer system to:
receive conversation data representing an analytical conversation between a user and a conversational interface;
construct, from the conversation data, a structured representation of the analytical conversation in accordance with a framework for analytical conversation components, wherein the structured representation comprises a plurality of analytical conversation components, including at least two of: one or more conversation turns, one or more conversation threads, one or more speech acts, one or more analysis artifacts, and one or more data insights;
store, for each respective conversation turn of the one or more conversation turns, data identifying a user query and a corresponding response of the conversational interface;
store, for each respective conversation thread of the one or more conversation threads, data identifying a coherent sequence of related conversation turns centered around an analytical topic or goal;
store, for each respective speech act of the one or more speech acts, a categorization of a respective user query according to an analysis-specific speech act taxonomy;
store, for each respective analysis artifact of the one or more analysis artifacts, data identifying a structured output generated in the analytical conversation and separate from natural language text;
store, for each respective data insight of the one or more data insights, data identifying an observation about data referenced in the analytical conversation;
establish associations among the analytical conversation components, including associating respective speech acts with respective conversation turns, associating respective analysis artifacts with respective conversation turns, associating respective data insights with one or more respective conversation turns, and associating respective conversation turns with respective conversation threads; and
store the structured representation as a machine-readable representation of the analytical conversation for subsequent retrieval, summarization, navigation, or reuse.
